(19) United States
(12) Patent Application Publication
(10) Pub. No.: US 2015/0089097 A1
(43) Pub. Date: Mar. 26, 2015

(54) I/O PROCESSING CONTROL APPARATUS AND I/O PROCESSING CONTROL METHOD

(71) Applicant: HITACHI, LTD., Tokyo (JP)

(72) Inventors: Yuya ISODA, Tokyo (JP); Atsushi TOMODA, Tokyo (JP)

(73) Assignee: HITACHI, LTD., Tokyo (JP)

(21) Appl. No.: 14/472,708

(22) Filed: Aug. 29, 2014

(30) Foreign Application Priority Data
Sep. 20, 2013 (JP) 2013-195002

(51) Int. Cl. G06F 3/06

(52) U.S. Cl. CPC G06F 3/0613; G06F 3/0655; G06F 3/0673
USPC 710/58

(57) ABSTRACT

An I/O processing control apparatus integrates, from among a plurality of unprocessed I/O requests, two or more I/O requests, which are for the same type of I/O process and have two or more noncontiguous areas as I/O destinations, into one I/O request targeted at one continuous area comprising the above-mentioned two or more noncontiguous areas, and executes I/O processing in relation to the storage device on the basis of the integrated I/O request.

### CROSS-REFERENCE TO PRIOR APPLICATION

This application relates to and claims the benefit of priority from Japanese Patent Application number 2013-195002, filed on Sep. 20, 2013, the entire disclosure of which is incorporated herein by reference.

### BACKGROUND

The present invention generally relates to technology for integrating a plurality of I/O requests.

A read process is an input/output (I/O) process. In a read process, data is acquired at high speed from a storage device, such as a hard disk drive (HDD), and therefore, when acquiring a plurality of data that is either logically or physically contiguous inside the storage device, a plurality of read requests by an application, an operating system (OS), a device driver, and the storage device is integrated and sent as a single read request. This enables a plurality of data read processes to be reduced to a single process, thereby making high-speed data acquisition possible.

Computation processing technologies have made phenomenal progress in recent years, and as a result of using multi-core technologies and asynchronous I/O techniques, there have been cases where computer systems issue more I/O processing requests than the number of I/Os capable of being processed by the storage device. As a result, the computer system must wait for the I/Os to be processed by the storage device, leading to the problem of a reduction in computation processing performance.

As a technique for dealing with this problem, Non Patent Literature 1 (Daniel P. Bovet and Marco Cesati, “Understanding the Linux Kernel,” P621) discloses a technique for executing a plurality of I/O processes for contiguous sector areas of a storage device as a single I/O process.

Also, in recent years, attention has focused on storage devices such as solid state drives (SSD) comprising flash memory as high-speed storage devices in place of HDDs. Generally speaking, flash memory is characterized by the fact that data overwriting is not possible.

As a data write procedure for a storage device that comprises flash memory like this, Patent Literature 1 (U.S. Pat. No. 5,499,337) discloses a technique which, when writing new data (updated data) to the storage device, involves reading a predetermined unit of data that includes old data (pre-update data corresponding to the new data), converting the old data in the predetermined unit of data to the new data, and writing the predetermined unit of data including the new data to the storage device. This techniques is called read modify write.

### SUMMARY

The technique disclosed in the aforementioned Non Patent Literature 1 enables a plurality of read requests that respectively correspond to a plurality of contiguous sector areas to be integrated into a single read request, thereby making it possible to reduce the number of read processes. However, in the case of a plurality of read requests for a plurality of noncontiguous sector areas, the plurality of read requests cannot be integrated, making it impossible to reduce the number of read processes.

For example, in a computer system that has a small number of cores, large numbers of I/O processes are not generated and the application and user deliberately issue an I/O process to a large sector area, and therefore an increase in I/O processes is not apt to cause a drop in computer system performance. However, there is the concern that I/O processes executed by a computer system will increase in accordance with multi-core technologies and asynchronous I/O techniques, and, in addition, that drops in computer system performance will occur frequently without the application and user being able to come to grips with the I/O processes.

In a storage device comprising flash memory, the problem is that writing is slow when updating data. For example, in the technique disclosed in Patent Literature 1, since a read that conforms to read modify write is generated in the data update process, this read is accompanied by a drop in storage device performance.

An object of the present invention is to reduce the number of I/O processes in relation to a storage device.

An I/O process control apparatus integrates, from among a plurality of unprocessed I/O requests, two or more I/O requests, which are for the same type of I/O process and have two or more noncontiguous areas as I/O destinations, into one I/O request that is targeted at one continuous area comprising the above-mentioned two or more noncontiguous areas, and executes the I/O processing in relation to the storage device on the basis of the integrated I/O request. Accordingly, it is possible to reduce the number of I/O processes in relation to a storage device.

### BRIEF DESCRIPTION OF THE DRAWINGS

FIG. 1 is a functional block diagram of a computer system.

FIG. 2 is a drawing illustrating an example of the configuration of a data part.

FIG. 3 is a drawing illustrating a segment area.

FIG. 4 is a drawing illustrating the configuration of a storage device.

FIG. 5 is a drawing illustrating a sector area.

FIG. 6 is a block diagram of an example of an I/O sector table.

FIG. 7 is a block diagram of an example of an I/O segment table.

FIG. 8 is a block diagram of an example of an I/O request table.

FIG. 9 is a block diagram of an example of an I/O environment configuration table.

FIG. 10 is a block diagram of an example of an I/O request queue table.

FIG. 11 is a block diagram of an example of an I/O information list.

FIG. 12 is a block diagram of an example of an I/O request list.

FIG. 13 is a block diagram of an example of an I/O sector reference table.

FIG. 14 is a block diagram of an example of an I/O sector reconstruction table.

FIG. 15 is a functional block diagram of a universal block part.

FIG. 16 is a functional block diagram of an I/O scheduler part.

FIG. 17 is a functional block diagram of a device driver part.

FIG. 18 is a functional block diagram of an I/O end processing part.

FIG. 19 is a flowchart of the processing of an I/O request creation determination part.

FIG. 20 is a flowchart of the processing of an I/O request integration/addition determination part.

FIG. 21 is a flowchart of determination processing of the I/O request integration/addition determination part.

FIG. 22 is a flowchart of the processing of an I/O sector end determination part.

FIG. 23 is a drawing illustrating an example of the hardware configuration of a computer system.

### DESCRIPTION OF EMBODIMENTS

A computer system, which is an example of an I/O processing control apparatus related to an embodiment of the present invention will be explained be referring to the drawings.

Furthermore, in the following explanation, the information of the present invention is explained using expressions such as “aaa table”, but this information may also be expressed using a data structure other than a table. Therefore, to show that this information is not dependent on the data structure, “aaa table” may be called “aaa information”.

In the following explanation, there may be cases where processing is explained giving as the subject of the sentence a functional part that is configured by executing a program, but since the stipulated processing is performed in accordance with a program being executed by a processor (for example a central processing unit (CPU)) while using a storage resource (for example, a memory) and/or a communication interface as needed, the processor may be considered to be the doer of the processing. A process, which is described having the functional part as the subject of the sentence, may be regarded as a process performed by an apparatus that includes the processor. Furthermore, the processor may include a hardware circuit that performs either all or a portion of the processing. A computer program may be installed in the apparatus from a program source. The program source, for example, may be a program delivery server or a computer readable storage medium.

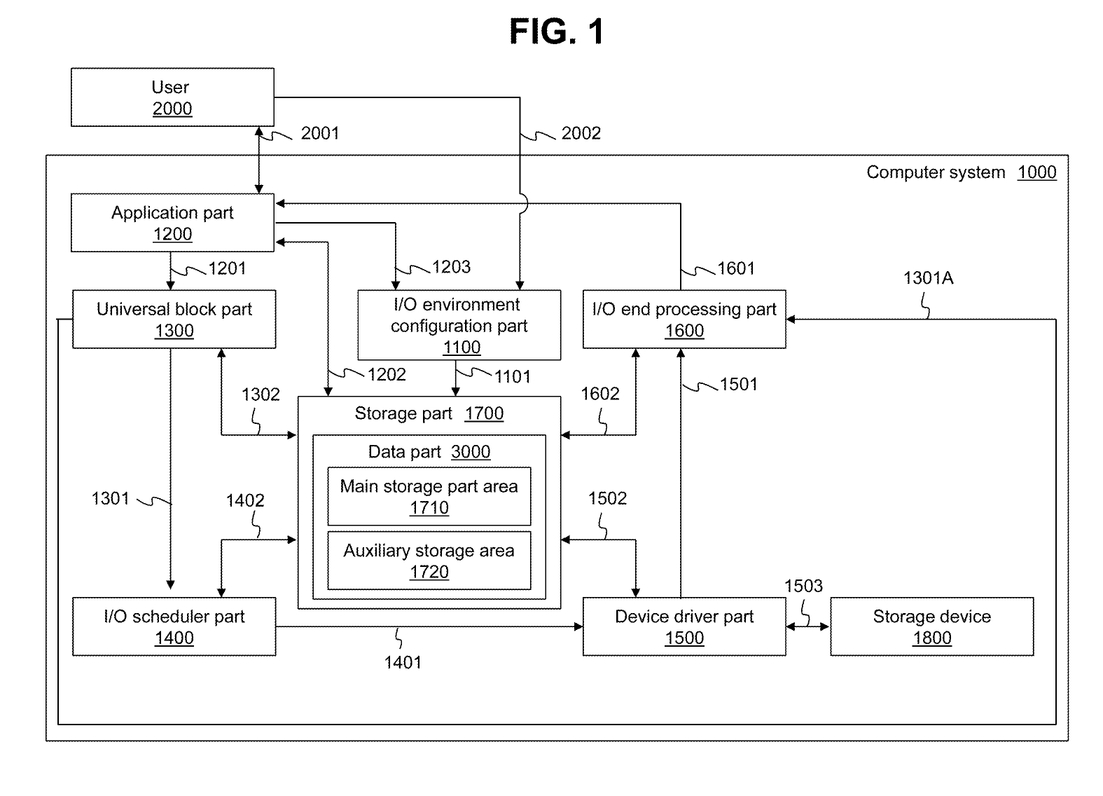

FIG. 1 is a functional block diagram of a computer system.

In a computer system 1000, a storage part 1700 stores a plurality of unprocessed I/O requests to a storage device 1800. Then, an I/O scheduler part 400 integrates, from among this plurality of I/O requests, a plurality of requests, which is for the same type of I/O process and has a plurality of noncontiguous areas as I/O destinations, into one I/O request that has one continuous area comprising this plurality of noncontiguous areas as the I/O destination. Thereafter, a device driver part 1500 executes the I/O process in relation to a storage device 1800 on the basis of the integrated I/O request. This makes it possible to reduce the number of I/O requests to the storage device 1800. This is particularly useful in an environment in which large numbers of I/O requests are generated.

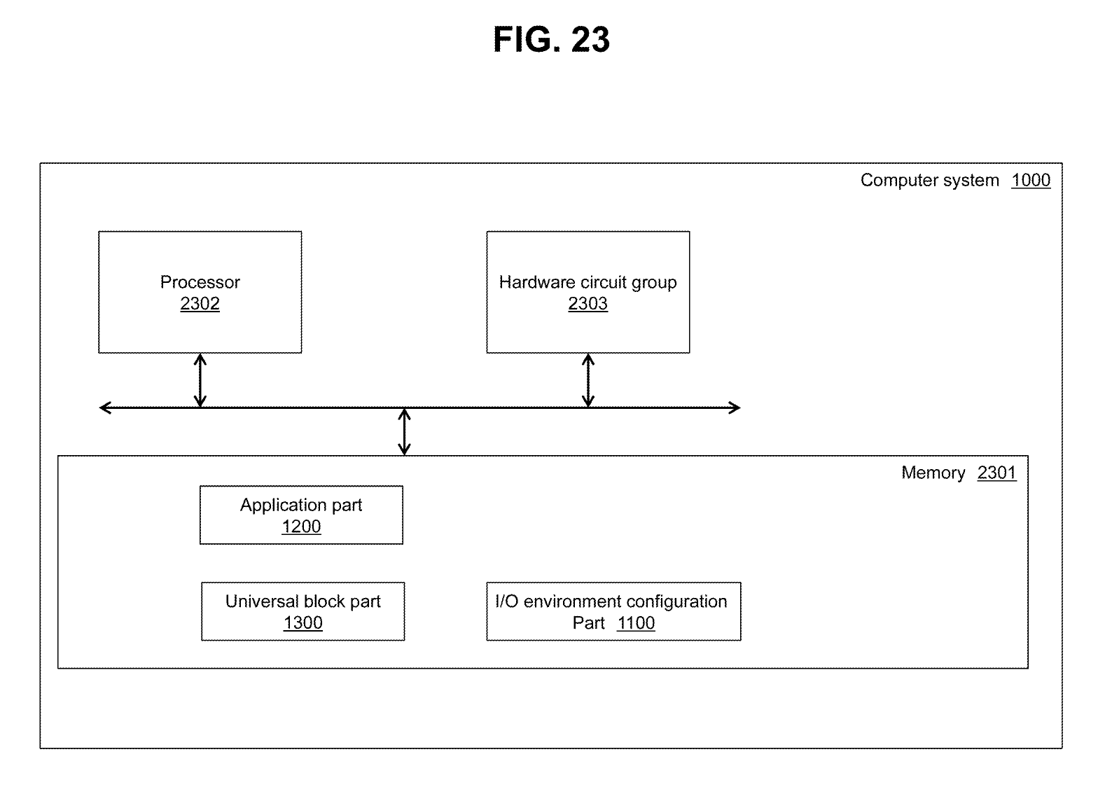

Specifically, for example, the computer system 1000 comprises an I/O environment configuration part 1100, an application part 1200, a universal block part 1300, an I/O scheduler part 1400, a device driver part 1500, an I/O end processing part 1600, a storage part 1700, and a storage device 1800. Furthermore, the I/O scheduler part 1400, the device driver part 1500, and the I/O end processing part 1600 may be configured in accordance with a processor executing a program, or may be configured using hardware. Specifically, for example, as illustrated in FIG. 23, the computer system 1000 may comprise a memory 2301, a hardware circuit group 2303, and a processor 2302 to which these components are connected. Of the functional parts illustrated in FIG. 1, the application part 1200, the universal block part 1300, and the I/O environment configuration part 1100 may each be a computer program, and may be executed by the processor 2302. Of the functional parts illustrated in FIG. 1, the functional parts other than the application part 1200, the universal block part 1300, and the I/O environment configuration part 1100 may each be hardware circuits, and, for example, may be included in the hardware circuit group 2303. The hardware circuit group 2303, for example, may be driver circuits in a lower-level layer than an operating system (OS).

A user 2000, as indicated by arrow 2001, can issue a computation processing instruction to the application part 1200 using an input device not shown in the drawing. Also, the user 2000, as indicated by arrow 2002, can use the not-shown input device to instruct the I/O environment configuration part 1100 to change the configuration of the I/O environment.

The storage part 1700 is configured using a main storage part and/or an auxiliary storage part. For example, the main storage part is configured using DRAM, and the auxiliary storage part is configured using a nonvolatile memory. The storage part 1700 comprises a data part 3000 for storing various data. A main storage part area 1710, which is a storage area of the main storage part, and/or an auxiliary storage part area 1720, which is a storage area of the auxiliary storage part, are allocated to the data part 3000. The data stored in the data part 3000 will be described below.

The storage device 1800 is a device for storing data, and, for example, may be an HDD or a flash memory device such as an SSD. The I/O environment configuration part 1100, as indicated by arrow 1203, receives an instruction from the application part 1200 to change the configuration of the I/O environment. In addition, the I/O environment configuration part 1100, as indicated by arrow 2002, receives an instruction from the user 2000 to change the configuration of the I/O environment. The I/O environment configuration part 1100, upon receiving an instruction to change the configuration of the I/O environment, as indicated by arrow 1101, updates predetermined data in the data part 3000 held in the storage part 1700.

The application part 1200 executes a predetermined computation process in accordance with a user 2000 computation process instruction. In the computation process, the application part 1200 accesses the desired data in the data part 3000 as indicated by arrow 1202. In the computation process, the application part 1200 also notifies the universal block part 1300 of the I/O processing instruction as needed as indicated by arrow 1201. The application part 1200 notifies the user 2000 of the result of the computation processing as indicated by arrow 2001.

The universal block part 1300, as indicated by arrow 1302, is able to access desired data in the data part 3000. The universal block part 1300, as indicated by arrow 1301, notifies the I/O scheduler part 1400 of the I/O processing instruction. The universal block part 1300, as indicated by arrow 1301A, notifies the I/O end processing part 1600 of the I/O processing instruction.

The I/O scheduler part 1400, as indicated by arrow 1402, is able to access desired data in the data part 3000. The I/O scheduler part 1400, as indicated by arrow 1401, also notifies the device driver part 1500 of the I/O processing instruction.

The device driver part 1500, as indicated by arrow 1502, is able to access desired data in the data part 3000. The device driver part 1500, as indicated by arrow 1503, is also able to access desired data in the storage device 1800. When I/O processing has ended, the device driver part 1500 notifies the I/O end processing part 1600 of I/O processing completion as indicated by arrow 1501. The I/O end processing part 1600, as indicated by arrow 1602, is able to access arbitrary data in the data part 3000. The I/O end processing part 1600, as indicated by arrow 1601, also notifies the application part 1200 of the completion of I/O processing.

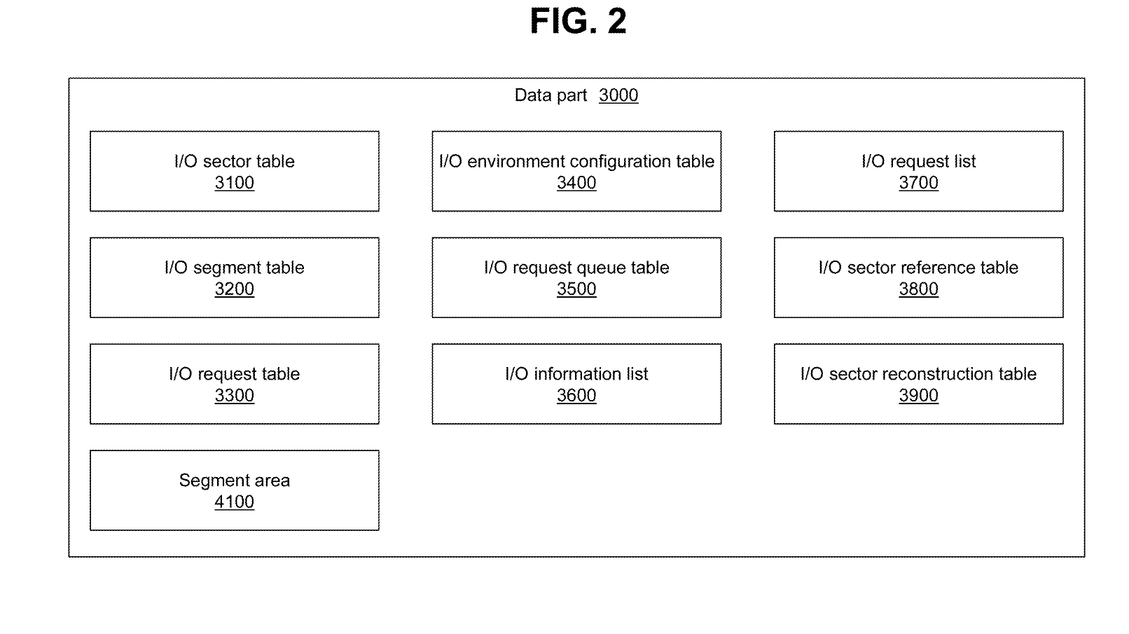

FIG. 2 is a drawing illustrating an example of the configuration of the data part 3000.

The data part 3000 comprises an I/O sector table 3100, an I/O segment table 3200, an I/O request table 3300, an I/O environment configuration table 3400, an I/O request queue table 3500, an I/O information list 3600, an I/O request list 3700, an I/O sector reference table 3800, an I/O sector reconstruction table 3900, and a segment area 4100. Each table will be explained in detail below.

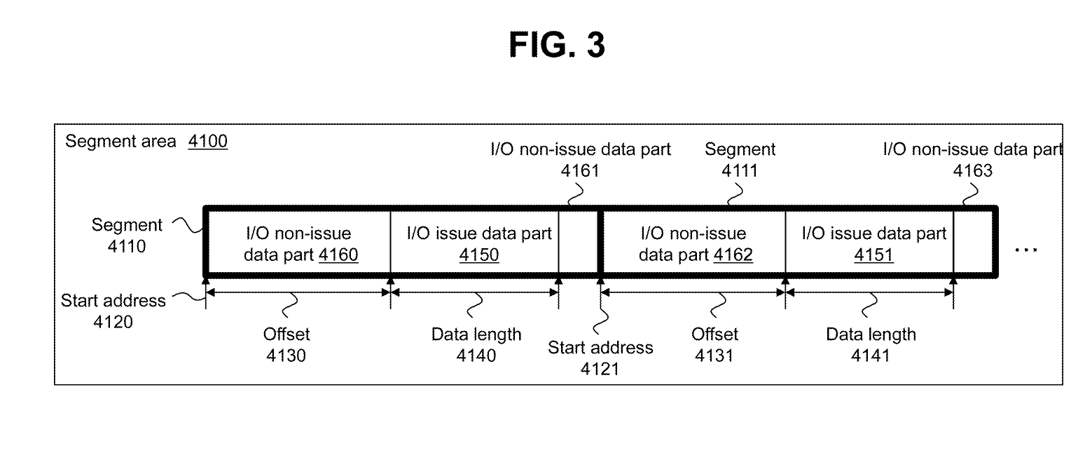

FIG. 3 is a drawing illustrating the segment area 4100.

The segment area 4100 is for storing segments (4110, 4111, and so forth), which are management units for managing data utilized by the application part 1200 in the data part 3000. In FIG. 3, the issue-target areas within a segment targeted by an I/O request are I/O issue data parts (4150, 4151, and so forth), and the other areas are I/O non-issue data parts (4160, 4161, 4162, 4163, and so forth). For example, the I/O issue data part 4150 of segment 4110 is defined by a start address 4120 of the segment 4110, an offset 4130 showing the address length from the start of the segment 4110 to the start of the I/O issue data part 4150, and a data length 4140 of the I/O issue data part 4150. Similarly, the area of the I/O issue data part 4151 of segment 4111 is defined by a start address 4121 of the segment 4111, an offset 4131 showing the address length from the start of the segment 4111 to the start of the I/O issue data part 4151, and a data length 4141 of the I/O issue data part 4151.

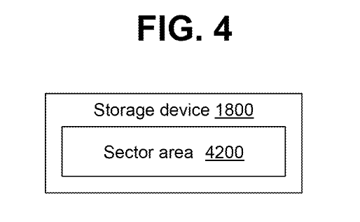

FIG. 4 is a drawing illustrating the configuration of the storage device 1800.

The storage device 1800 comprises a sector area 4200 for managing a sector, which is the area that serves as the data access unit in an I/O process in relation to the storage device 1800.

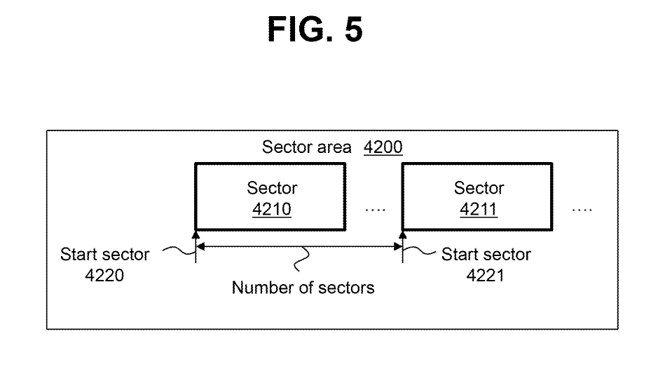

FIG. 5 is a drawing illustrating the sector area 4200.

The sector area 4200 stores a plurality of sectors (4210, 4211, and so forth). For example, the area from the sector 4210 to a sector immediately before the sector 4211 is defined by a sector number of the sector 4210, which is the start sector 4220 of the area, and a number of sectors 4230, which is the difference between the sector number of the start sector 4220 and the sector number of the sector 4211, which is the next start sector 4221 of this area.

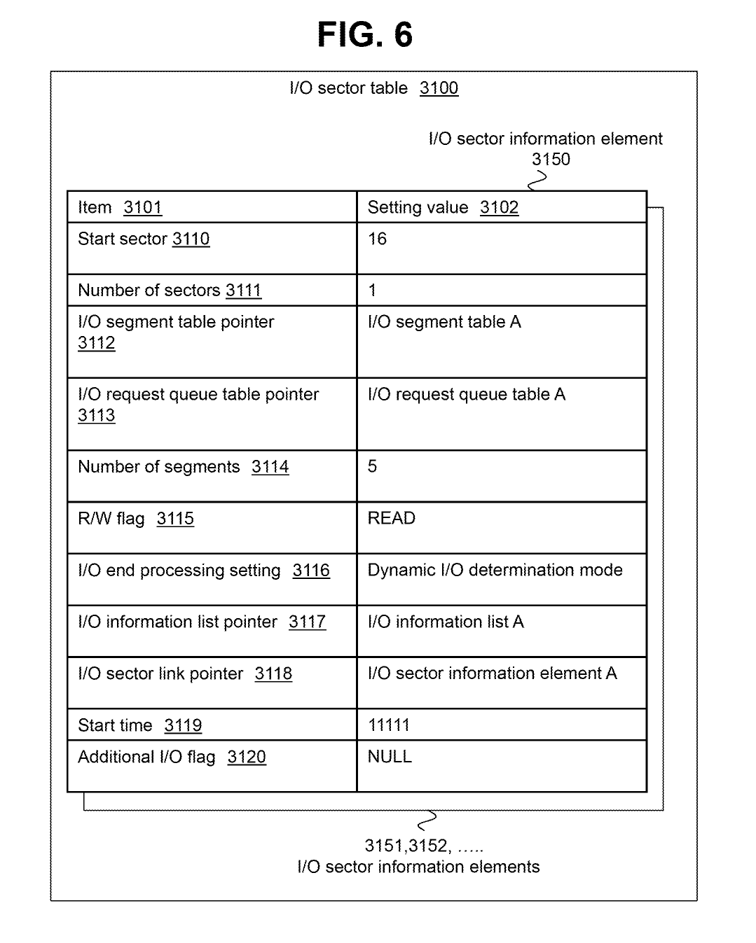

FIG. 6 is a block diagram of an example of an I/O sector table 3100. The I/O sector table 3100 comprises I/O sector information elements (3150, 3151, 3152, and so forth) for managing an area of the storage device 1800 that is targeted for I/O processing. Since the configurations of the I/O sector information elements are the same, an explanation will be given here using I/O sector information element 3150. I/O sector information element 3150 comprises the fields of an item 3101, and a setting value 3102 for storing a setting value corresponding to an item. In the item 3101 column, there is stored a start sector 3110, a number of sectors 3111, an I/O segment table pointer 3112, an I/O request queue table pointer 3113, a number of segments 3114, an R/R flag 3115, an I/O end processing setting 3116, an I/O information list pointer 3117, an I/O sector link pointer 3118, a start time 3119, and an additional I/O flag 3120. In the setting value 3102 column, there is stored a setting value corresponding to each item of the item 3101.

The start sector 3110 shows the sector number of the start sector of the area in the storage device 1800 that is the target of an I/O request (I/O-target sector area). The number of sectors 3111 shows the number of sectors in the I/O-target sector area. The I/O segment table pointer 3112 shows a pointer to the I/O segment table 3200 that manages the area of the data part 3000 that is the target of the I/O request. The I/O request queue table pointer 3113 shows a pointer to the I/O request queue table 3500. The number of segments 3114 shows the number of segments. The R/W flag 3115 shows a flag that depicts the type of I/O process based on the I/O request, and, for example, shows a flag that depicts whether it is a READ (R: read) or a WRITE (W: write). The I/O end processing setting 3116 shows the setting for I/O end processing. The I/O information list pointer 3117 shows a pointer to the I/O information list 3600. The I/O sector link pointer 3118 shows a pointer to another I/O sector information element included in a single I/O request. The start time 3119 shows the time at which I/O processing started in relation to the storage device 1800 area related to the I/O sector information element. The additional I/O flag 3120 is a flag showing whether the area related to the I/O sector information element is an area (additional area) of the storage device 1800 added when a plurality of I/O requests are integrated into a single I/O request. When the area related to the I/O sector information element is an area of the storage device 1800 that was added when integrating a plurality of I/O requests into a single I/O request, the setting value of the additional I/O flag 3120 is configured to ON, and when this is not the case, is configured to OFF.

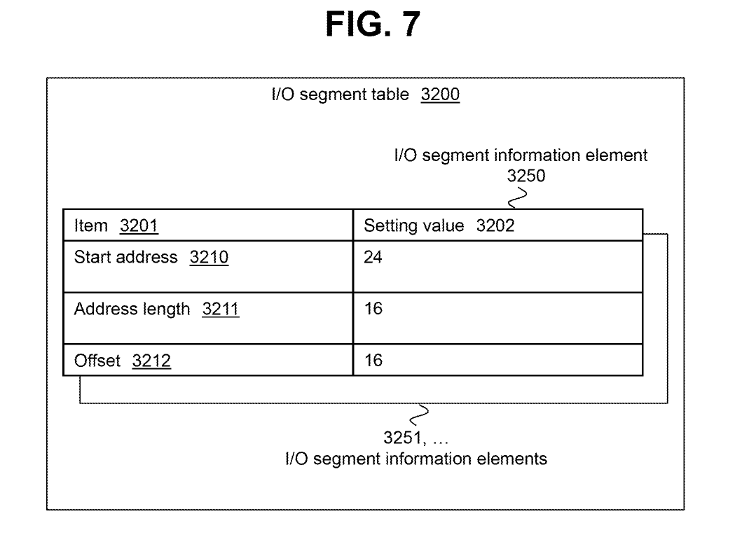

FIG. 7 is a block diagram of an example of the I/O segment table 3200.

The I/O segment table 3200 comprises I/O segment information elements (3250, 3251, and so forth) for managing the area of the storage part 1700 that is the target of an I/O request. Since the configurations of the I/O segment information elements are the same, an explanation will be given here using I/O segment information element 3250. I/O segment information element 3250 comprises the fields of an item 3201, and a setting value 3202 for storing a setting value corresponding to an item. In the item 3201 column, there is stored a start address 3210, an address length 3211, and an offset 3212. In the setting value 3202 column, there is stored a setting value corresponding to each item of the item 3201.

The start address 3210 shows the start address of a segment that includes the data part 3000 area that is the target of the I/O request. The address length 3211 shows the length of the address of the data part 3000 area that is the target of the I/O request. The offset 3212 shows the offset from the start of the segment to the start of the data part 3000 area that is the target of the I/O request.

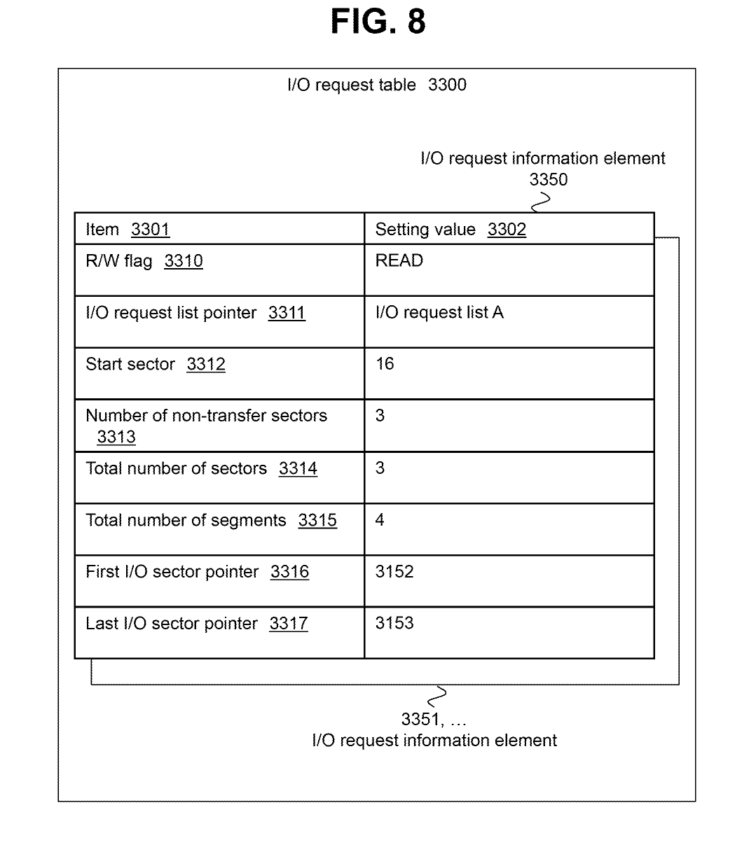

FIG. 8 is a block diagram of an example of the I/O request table 3300.

The I/O request table 3300 comprises one I/O request information element (3350, 3351, and so forth) for each I/O request to the storage device 1800. Therefore, one I/O request information element corresponds to one I/O request, and one (a one-time) I/O process is executed in relation to the storage device 1800 in accordance with one I/O request information element. Since the configurations of the I/O request information elements are the same, an explanation will be given here using I/O request information element 3350. I/O request information element 3350 comprises the fields of an item 3301, and a setting value 3302 for storing a setting value corresponding to an item. In the item 3301 column, there is stored a R/W flag 3310, an I/O request list pointer 3311, a start sector 3312, a number of non-transfer sectors 3313, a total number of sectors 3314, a total number of segments 3315, a first I/O sector pointer 3316, and a last I/O sector pointer 3317. In the setting value 3302 column, there is stored a setting value corresponding to each item of the item 3301.

The R/W flag 3310 shows a flag depicting the type of I/O process to be executed. The setting values for the R/W flag 3310 are WRITE for writing data to the storage device 1800, and READ for reading data from the storage device 1800. The I/O request list pointer 3311 shows a pointer to the I/O request list 3700 for managing a plurality of I/O request information elements. The start sector 3312 shows the sector number of the start sector in the storage device 1800 area that is the target of the I/O request. The number of non-transfer sectors 3313 shows the number of non-transfer sectors among the sectors that are the targets of the I/O request. The total number of sectors 3314 shows the total number of sectors in the I/O request-target area. The total number of segments 3315 shows the total number of segments in the storage part 1700 area that is the target of the I/O request. The first I/O sector pointer 3316 shows a pointer to the I/O sector information element indicating the first I/O request-target area corresponding to the I/O request information element. The last I/O sector pointer 3317 shows a pointer to the I/O sector information element indicating the last I/O request-target area corresponding to the I/O request information element.

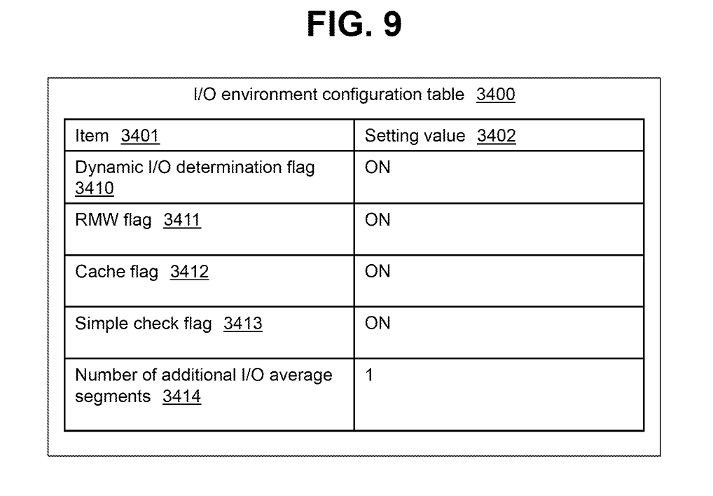

FIG. 9 is a block diagram of an example of the I/O environment configuration table 3400.

The I/O environment configuration table 3400 is for managing the configuration for the I/O environment, and comprises the fields of an item 3401, and a setting value 3402 for storing a setting value corresponding to an item. In the item 3401 column, there is stored as I/O environment configuration items a dynamic I/O determination flag 3410, an RMW flag 3411, a cache flag 3412, a simple check flag 3413, and a number of additional I/O averaging segments 3414. In the setting value 3402 column, there is stored a setting value corresponding to each item of the item 3401. In this arrangement, the setting value for each item is configured by the user and/or the application part 1200.

The dynamic I/O determination flag 3410 shows a flag that indicates whether or not a dynamic I/O determination will be performed to determine whether or not a plurality of I/O requests is to be dynamically integrated into a single I/O request. The setting value for the dynamic I/O determination flag 3410 is configured to ON when a dynamic I/O determination is to be performed, and is configured to OFF when a dynamic I/O determination is not to be performed. The RMW flag 3411 shows a flag that indicates whether or not read-modify-write (RMW) is to be executed in relation to the storage device 1800. For example, when the storage device 1800 is an SSD, the setting value of the RMW flag 3411 may be configured to ON. The cache flag 3412 shows a flag that indicates whether or not caching is to be performed for data read from the storage device 1800. The setting value for the cache flag 3412 is configured to ON when caching is to be performed, and is configured to OFF when caching is not to be performed. The simple check flag 3413 shows a flag that indicates whether or not a simple check only will be performed in the dynamic I/O determination. When only a simple check is to be done, the setting value of the simple check flag 3413 is configured to ON, and is configured to OFF when a detailed check is to be performed. The number of additional I/O averaging segments 3414 shows the average number of segments to be added to an I/O request for the sake of integration when dynamically integrating a plurality of I/O request into a single I/O request.

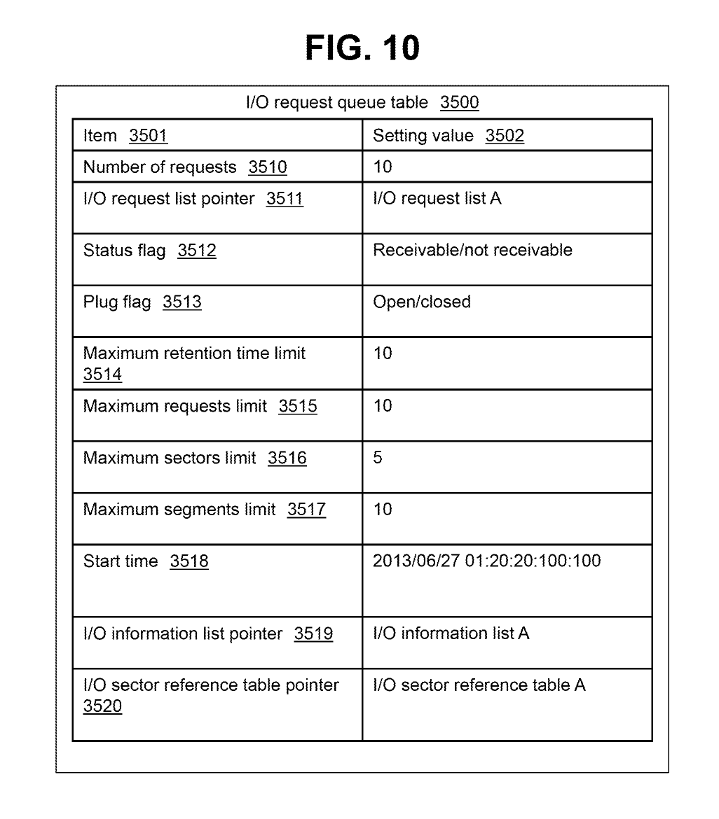

FIG. 10 is a block diagram of an example of the I/O request queue table 3500.

The I/O request queue table 3500 is for managing a queue of I/O requests (I/O request queue), and comprises an item 3501, and a setting value 3502 for storing a setting value corresponding to an item. In the item 3501 column, there is stored a number of requests 3510, an I/O request list pointer 3511, a status flag 3512, a plug flag 3513, a maximum retention time limit 3514, a maximum requests limit 3515, a maximum sectors limit 3516, a maximum segments limit 3517, a start time 3518, an I/O information list pointer 3519, and an I/O sector reference table pointer 3520. In the setting value 3502 column, there is stored a setting value corresponding to each item of the item 3501.

The number of requests 3510 shows the number of I/O requests being managed in the I/O request queue. The I/O request list pointer 3511 shows a pointer to the I/O request list 3700 for managing I/O requests. The status flag 3512 shows a flag that indicates the reception status of an I/O request. When it is possible to receive a new I/O request, the setting value for the status flag 3512 is receivable, and when it is not possible to receive a new I/O request, the setting value for the status flag 3512 becomes not receivable. The plug flag 3513 is a flag that indicates whether or not an I/O request is in a queued state. When an I/O request is not queued, the plug flag 3513 setting value is closed, and when the I/O request is queued, the plug flag 3513 setting value is open. The maximum retention time limit 3514 shows the maximum period of time that an I/O request may be retained in the queue. The maximum requests limit 3515 shows the maximum number of I/O requests capable of being accumulated in the queue. The maximum sectors limit 3516 shows the maximum number of sectors that can be targeted by one I/O request. The maximum segments limit 3517 shows the maximum number of segments that can be targeted by one I/O request. The start time 3518 shows the time at which I/O requests began being retained in the queue. The I/O information list pointer 3519 shows a pointer to the I/O information list 3600 for managing an I/O information element, which will be explained below. The I/O sector reference table pointer 3520 shows a pointer to the I/O sector reference table 3800.

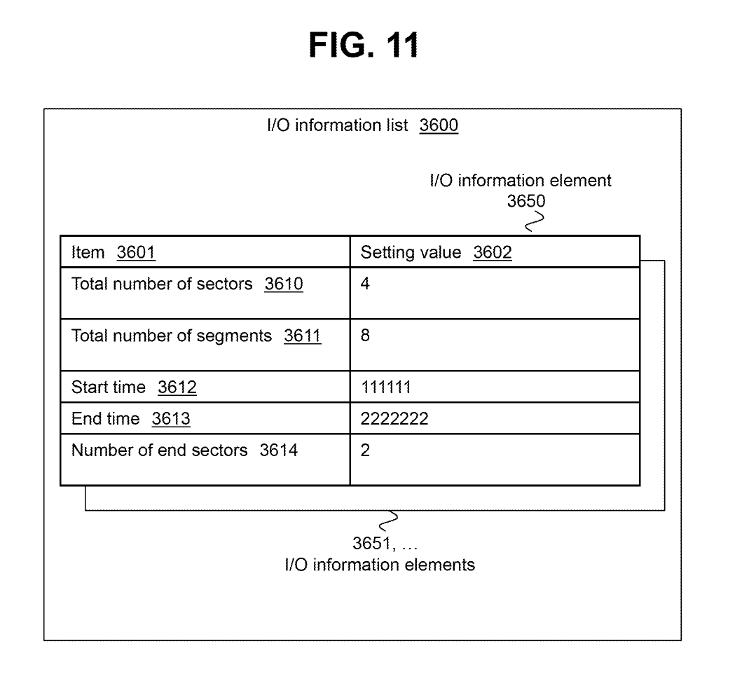

FIG. 11 is a block diagram of an example of the I/O information list 3600.

The I/O information list 3600 comprises one I/O information element (3650, 3651, and so forth) for each I/O request. Since the configurations of the I/O information elements are the same, an explanation will be given here using I/O information element 3650. The I/O information element 3650 comprises the fields of an item 3601, and a setting value 3602 for storing a setting value corresponding to an item. In the item 3601 column, there is stored a total number of sectors 3610, a total number of segments 3611, a start time 3612, an end time 3613, and a number of ended sectors 3614. In the setting value 3602 column, there is stored a setting value corresponding to each item of the item 3601.

The total number of sectors 3610 shows the total number of sectors in the storage device 1800 area that is the target of an I/O request. The setting value of the total number of sectors 3610 makes it possible to identify the length of the storage device 1800 area that is the target of the I/O request. The total number of segments 3611 shows the total number of segments in the storage part 1700 area that is the target of the I/O request. The start time 3612 shows the time at which I/O processing based on the I/O request got started. The end time 3613 shows the time at which the I/O processing based on the I/O request ended. In this arrangement, it is possible to identify the I/O processing execution time by subtracting the setting value of the start time 3612 from the setting value of the end time 3613. The number of ended sectors 3614 shows the number of sectors for which I/O processing based on the I/O request has ended.

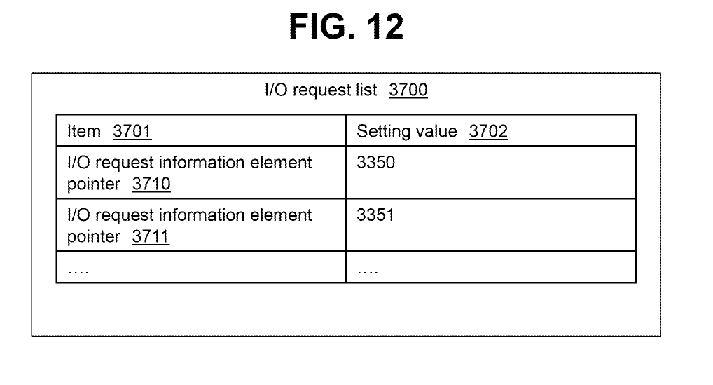

FIG. 12 is a block diagram of an example of the I/O request list 3700.

The I/O request list 3700 is for managing I/O request information elements corresponding to a plurality of I/O requests, and comprises an item 3701, and a setting value 3702 for storing a setting value corresponding to an item. In the item 3701 column, there is stored I/O request information element pointers (3710, 3711, . . . ). In the setting value 3702 column, there is stored a setting value corresponding to each item in the item 3701. The I/O request information element pointers 3710, 3711, . . . show pointers to I/O request information elements corresponding to the respective I/O requests.

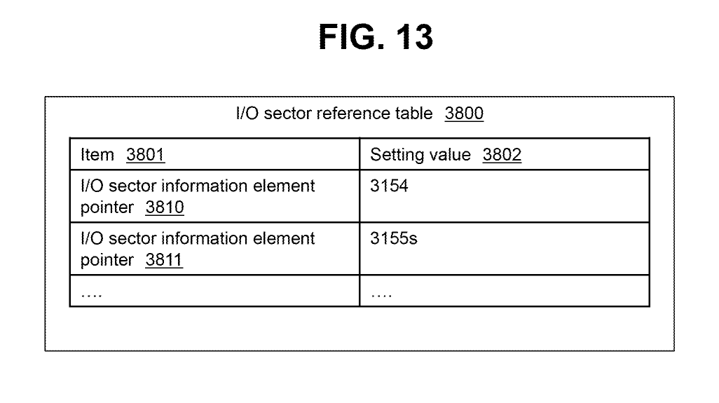

FIG. 13 is a block diagram of an example of the I/O sector reference table 3800.

The I/O sector reference table 3800 is for managing in a referenceable manner the I/O sector information elements corresponding to storage device 1800 areas for which data is cached in the storage part 1700, and comprises an item 3801, and a setting value 3802 for storing a setting value corresponding to an item. In the item 3801 column, there is stored I/O sector information element pointers (3810, 3811, . . . ). In the setting value 3802 column, there is stored a setting value corresponding to each item in the item 3801. The I/O sector information element pointer (3810, 3811, . . . ) indicates a pointer to an I/O sector information element corresponding to a storage device 1800 area for which data is cached in the storage part 1700.

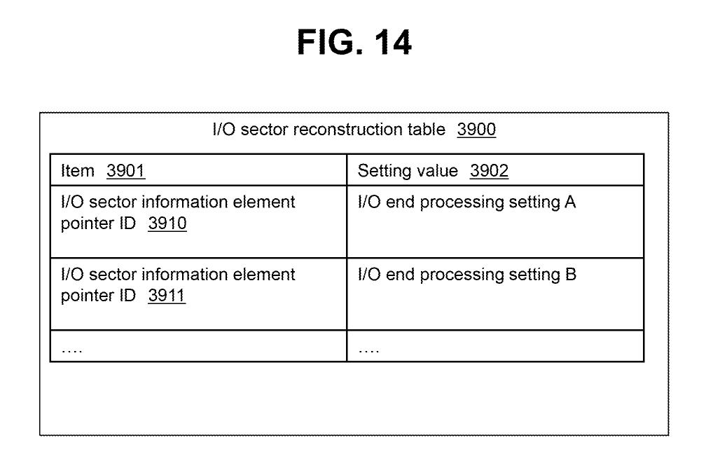

FIG. 14 is a block diagram of an example of the I/O sector reconstruction table 3900.

The I/O sector reconstruction table 3900 comprises an item 3901, and a setting value 3902 for storing a setting value corresponding to an item. In the item 3901 column, there is stored I/O sector information element pointer IDs 3910, 3911, . . . . In the setting value 3902 column, there is entered a setting value corresponding to each item in the item 3901. The I/O sector information element IDs 3910, 3911, . . . show the IDs of the I/O sector information element pointers. In this embodiment, this ID setting value shows the setting in the I/O end processing. The I/O sector information element pointer ID is a value unique to an I/O sector information element. The I/O sector information element pointer ID, for example, may be defined by a start sector, a number of sectors, an R/W flag, and a start time. When changing the I/O end processing setting 3116 in a dynamic I/O determination mode, I/O end processing A and B are areas for storing original data (the data prior to the change performed in the dynamic I/O determination mode). An instruction for either notifying or concealing the completion of the I/O may be registered in the original data.

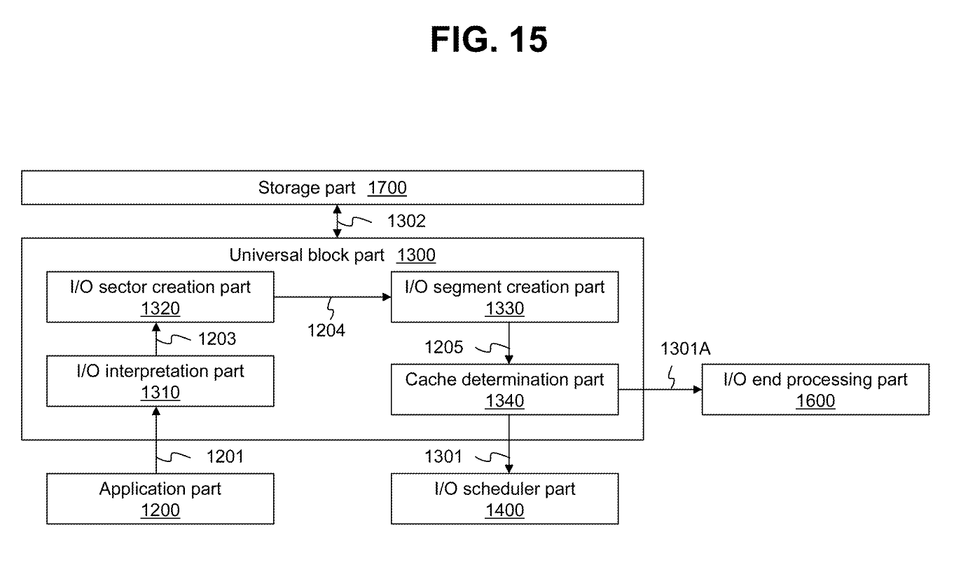

FIG. 15 is a function block diagram of the universal block part 1300.

The universal block part 1300 comprises an I/O interpretation part 1310, an I/O sector creation part 1320, an I/O segment creation part 1330, and a cache determination part 1340.

The I/O interpretation part 1310 of the universal block part 1300, as indicated by arrow 1201, receives an I/O processing instruction from the application part 1200. The I/O interpretation part 1310 extracts from the I/O processing instruction data included in the I/O processing instruction (for example, the start sector for the I/O processing-target area of the storage device 1800, the number of sectors inside this target area, the I/O request queue table pointer, the R/W flag, the I/O end processing setting, the start address for the segment that includes the I/O processing-target area of the storage part 1700, the address length of this target area, and the offset from the start of the segment to the target area). The I/O interpretation part 1310 sends the extracted data group to the I/O sector creation part 1320 as indicated by arrow 1203.

The I/O sector creation part 1320, as indicated by arrow 1302, creates an I/O sector information element (for example, I/O sector information element 3150) corresponding to the I/O processing instruction in the I/O sector table 3100 of the storage part 1700. The I/O sector creation part 1320 stores values corresponding to the respective items included in the data group received from the I/O interpretation part 1310 in the setting value 3102 column of the I/O sector information element 3150 corresponding to the start sector 3110, the number of sectors 3111, the I/O request queue table pointer 3113, the R/W flag 3115, and the I/O end processing setting 3116. Next, the I/O sector creation part 1320, as indicated by arrow 1204, sends the I/O sector information element 3150, and the start address, address length, and offset received from the I/O interpretation part 1310 to the I/O segment creation part 1330. The I/O segment creation part 1330, as indicated by arrow 1302, creates an I/O segment information element (for example, the I/O segment information element 3250) in the I/O segment table 3200 of the storage part 1700 on the basis of the various data sent from the I/O sector creation part 1320. The I/O segment creation part 1330 stores the values received from the I/O sector creation part 1320 in the setting value 3202 column of the I/O segment information element 3250 corresponding to the start address 3210, the address length 3211, and the offset 3212. The I/O segment creation part 1330 also configures a pointer to the I/O segment table 3200 to which the I/O segment information element 3250 belongs as the setting value corresponding to the I/O segment table pointer 3112 of the I/O sector information element 3150. In addition, the I/O segment creation part 1330 configures the sum total of I/O segment information elements 3250 held in the I/O segment table 3200 as the setting value corresponding to the number of segments 3114 of the I/O sector information element 3150. Lastly, the I/O segment creation part 1330, as indicated by arrow 1205, transfers the I/O sector information element 3150 and the I/O segment information element 3250 to the cache determination part 1340.

The cache determination part 1340, as indicated by arrow 1302, references the setting value for the cache flag 3412 of the I/O environment configuration table 3400 in the storage part 1700. A case where the setting value for the cache flag 3412 is OFF signifies that the I/O request-target data is not cached in the storage part 1700, and as such, the cache determination part 1340, as indicated by arrow 1301, sends the I/O sector information element 3150 to the I/O scheduler part 1400.

Alternatively, when the setting value of the cache flag 3412 is ON, there is a likelihood of the I/O request-target data being cached in the storage part 1700, and as such, the cache determination part 1340, as indicated by arrow 1302, references the I/O sector reference table 3800 of the storage part 1700. When the setting value of R/W flag 3115 of the I/O sector information element 3150 received from the I/O segment creation part 1330 is WRITE at this time, the cache determination part 1340 transfers the I/O sector information element 3150 to the I/O scheduler part 1400. Alternatively, when the setting value of R/W flag 3115 of the I/O sector information element 3150 received from the I/O segment creation part 1330 is READ, the cache determination part 1340 determines whether or not data corresponding to the I/O request is cached in the storage part 1700. Specifically, the cache determination part 1340 checks whether or not the I/O sector reference table 3800 is holding the I/O sector information element that is targeting an area comprising the area (called the I/O-target area in the explanation of the processing of the cache determination part 1340) that includes a number of sectors that is equivalent to the setting value of the number of sectors 3111 from the start sector indicated by the setting value of the start sector 3110 of the I/O sector information element 3150. A case in which the result is that such an I/O sector information element is not being held in the I/O sector reference table 3800 signifies that data corresponding to the I/O request is not being cached, and as such, the cache determination part 1340 sends the I/O sector information element 3150 to the I/O scheduler part 1400.

Alternatively, a case in which the I/O sector reference table 3800 is holding such an I/O sector information element signifies that data corresponding to the I/O request is being cached, and as such, the cache determination part 1340 identifies the I/O segment table 3200 from the setting value of the I/O segment table pointer 3112 in the I/O sector information element being held in the I/O sector reference table 3800, identifies, from the identified I/O segment table 3200, the area of the storage part 1700 where the I/O-target area data is being stored, and replicates the data in the identified area in the area of the storage part 1700 defined by the I/O segment information element 3250 received from the I/O segment creation part 1330. Thereafter, the cache determination part 1340 deletes the referenced I/O sector information element from the I/O sector reference table 3800, and, as indicated by arrow 1301A, moves the processing to the I/O end processing part 1600.

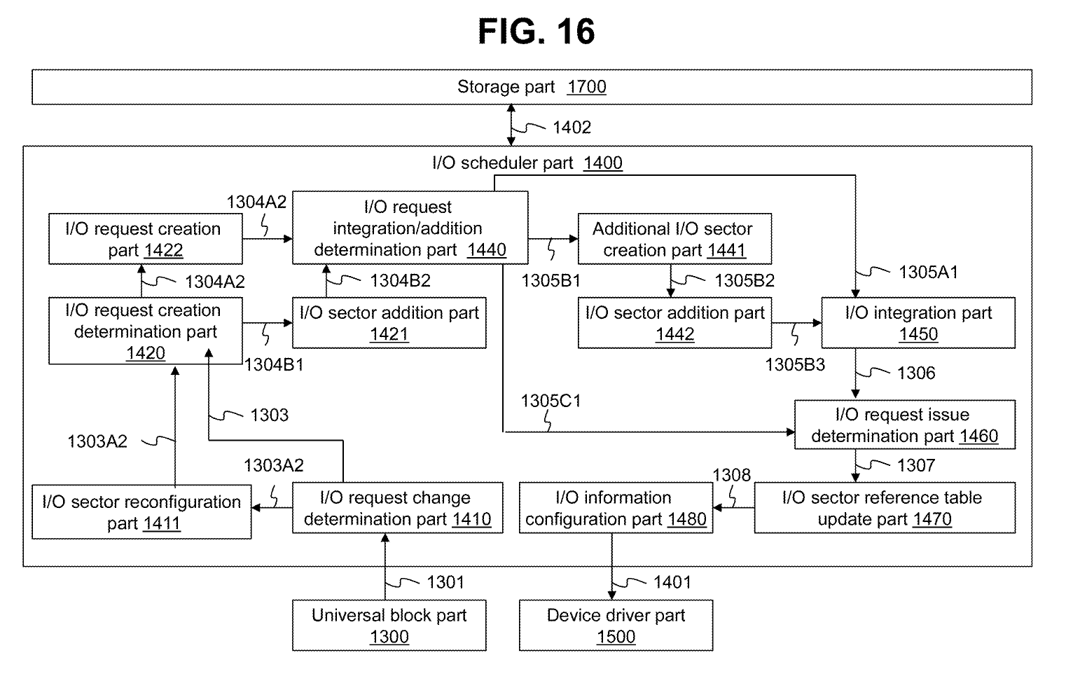

FIG. 16 is a functional block diagram of the I/O scheduler part 1400.

The I/O scheduler part 1400 comprises an I/O request change determination part 1410, an I/O sector reconfiguration part 1411, an I/O request creation determination part 1420, an I/O sector addition part 1421, an I/O request creation part 1422, an I/O request integration/addition determination part 1440, an additional I/O sector creation part 1441, an I/O sector addition part 1442, an I/O integration part 1450, an I/O request issue determination part 1460, an I/O sector reference table update part 1470, and an I/O information configuration part 1480.

The I/O request change determination part 1410, as indicated by arrow 1301, receives the I/O sector information element 3150 from the universal block part 1300. Upon receiving the I/O sector information element, the I/O request change determination part 1410, as indicated by arrow 1402, references the setting value of the dynamic I/O determination flag 3410 of the I/O environment configuration table 3400 in the storage part 1700, and when the setting value of the dynamic I/O determination flag 3410 is ON, as indicated by arrow 1303A1, moves the processing to the I/O sector reconfiguration part 1411, and alternatively, when the setting value of the dynamic I/O determination flag 3410 is OFF, as indicated by arrow 1303, moves the processing to the I/O request creation determination part 1420.

The I/O sector reconfiguration part 1411 associatively stores the received I/O sector information element 3150 and the I/O end processing setting 3116 in the I/O sector information pointer ID 3910 of the I/O sector reconstruction table 3900. Thereafter, the I/O sector reconfiguration part 1411 changes the setting value of the I/O end processing setting 3116 of the I/O sector information element 3150 to the dynamic I/O determination mode. The I/O sector reconfiguration part 1411, as indicated by arrow 1303A2, sends the I/O sector information element 3150 to the I/O request creation determination part 1420.

The I/O request creation determination part 1420 receives the I/O sector information element 3150 from either the I/O request change determination part 1410 or the I/O sector reconfiguration part 1411. The processing of the I/O request creation determination part 1420 will be explained here by referring to a drawing.

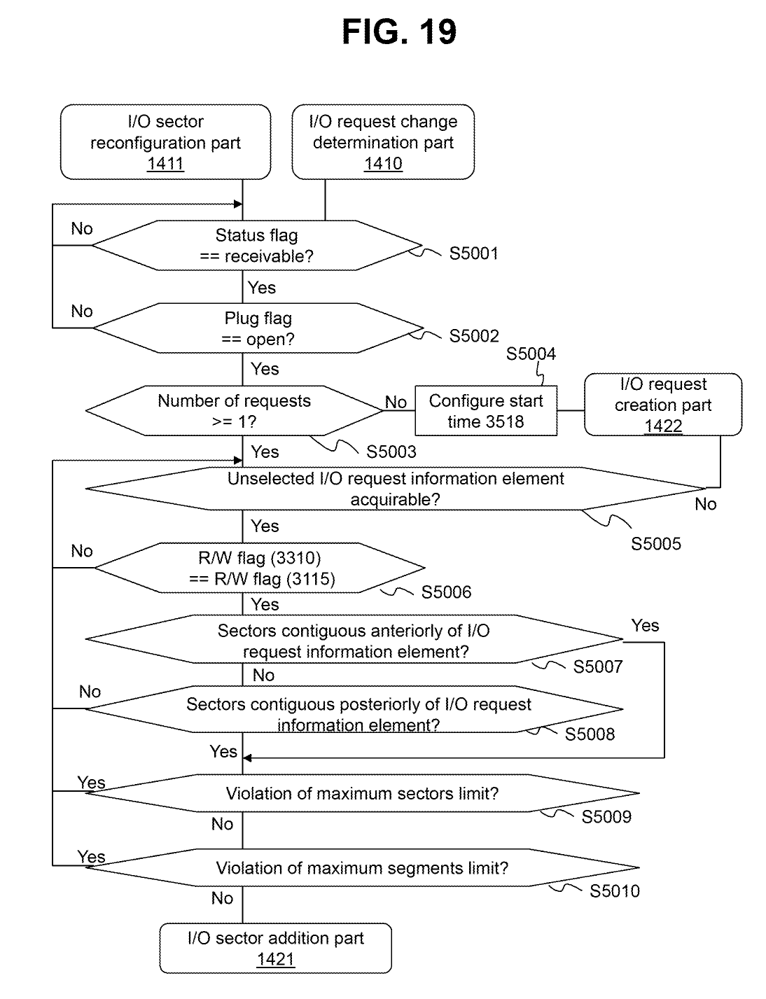

FIG. 19 is a flowchart of the processing of the I/O request creation determination part 1420.

In S5001, the I/O request creation determination part 1420 references the setting value of the status flag 3512 of the I/O request queue table 3500 indicated by the setting value in I/O request queue table pointer 3113 of the received I/O sector information element 3150, and determines whether or not an I/O request can be received. When the result of this determination is that the I/O request can be received (S5001: Yes), the I/O request creation determination part 1420 advances the processing to S5002, and alternatively, when the determination is that the I/O request can not be received (S5001: No), re-executes the processing of S5001.

In S5002, the I/O request creation determination part 1420 determines whether or not the setting value of the plug flag 3513 in the I/O request queue table 3500 is open. When the determination result is that the plug flag 3513 setting value is open (S5002: Yes), the I/O request creation determination part 1420 sets the setting value of the status flag 3512 in the I/O request queue table 3500 to not receivable, and advances the processing to S5003, and, alternatively, when it has been determined that the plug flag 3513 setting value is not open (S5002: No), the I/O request creation determination part 1420 moves the processing to S5001.

In S5003, the I/O request creation determination part 1420 determines whether or not the setting value of the number of requests 3510 in the I/O request queue table 3500 is equal to or larger than 1. When the result is that the setting value of the number of requests 3510 is not equal to or larger than 1 (S5003: No), the I/O request creation determination part 1420 advances the processing to S5004, and, alternatively, when the setting value of the number of requests 3510 is equal to or larger than 1 (S5003: Yes), advances the processing to S5005.

In S5004, the I/O request creation determination part 1420 configures the current time to the start time 3518 in the I/O request queue table 3500, and shifts the processing to the I/O request creation part 1422.

In S5005, the I/O request creation determination part 1420 identifies the I/O request list 3700 indicated by the I/O request list pointer 3511 in the I/O request queue table 3500, and determines whether or not all the I/O request information element pointers (3710, 3711, . . . ) of the identified I/O request list 3700 have been selected as processing targets. When the result is that there are unselected I/O request information element pointers (S5005: Yes), the I/O request creation determination part 1420 acquires the I/O request information element indicated by the I/O request information element pointer 3710 as the processing target, and advances the processing to S5006, and, alternatively, when there are no unselected I/O request information elements (S5005: No), shifts the processing to the I/O request creation part 1422.

In S5006, the I/O request creation determination part 1420 determines whether or not the setting value for the R/W flag 3310 of the acquired I/O request information element is the same as the setting value for the R/W flag 3115 of the I/O sector information element 3150. When the result is that the setting value for the R/W flag 3310 is the same as the setting value for the R/W flag 3115 of the I/O sector information element 3150 (S5006: Yes), there is the likelihood that a plurality of I/O requests can be integrated into one, and as such, the I/O request creation determination part 1420 advances the processing to S5007, and, alternatively, when the setting value for the R/W flag 3310 is not the same as the setting value for the R/W flag 3115 of the I/O sector information element 3150 (S5006: No), moves the processing to S5005.

In S5007, the I/O request creation determination part 1420 determines whether or not the range of sectors corresponding to the I/O sector information element 3150 is contiguous sectors preceding the start sector 3312 of the I/O request information element 3350. Specifically, the I/O request creation determination part 1420 makes a determination in accordance with whether or not the sum of the setting value for the start sector 3110 of the I/O sector information element 3150 and the setting value for the number of sectors 3111 is equal to the setting value for the start sector 3312 of the I/O request information element 3350. When the result is that the range of sectors corresponding to the I/O sector information element 3150 is contiguous sectors preceding the start sector 3312 of the I/O request information element 3350 (S5007: Yes), the I/O request creation determination part 1420 advances the processing to S5009, and, alternatively, when the range of sectors corresponding to the I/O sector information element 3150 is not contiguous sectors preceding the start sector 3312 of the I/O request information element 3350 (S5007: No), advances the processing to S5008.

In S5008, the I/O request creation determination part 1420 determines whether or not the range of sectors corresponding to the I/O sector information element 3150 is contiguous sectors following the range of sectors corresponding to the I/O request information element 3350. Specifically, the I/O request creation determination part 1420 makes a determination in accordance with whether or not the sum of the setting value for the start sector 3312 of the I/O request information element 3350 and the setting value for the total number of sectors 3314 are equal to the setting value for the start sector 3110 of the I/O sector information element 3150. When the result is that the range of sectors corresponding to the I/O sector information element 3150 is contiguous sectors following the range of sectors corresponding to the I/O request information element 3350 (S5008: Yes), the I/O request creation determination part 1420 advances the processing to S5009, and, alternatively, when the range of sectors corresponding to the I/O sector information element 3150 is not contiguous sectors following the range of sectors corresponding to the I/O request information element 3350 (S5008: No), moves the processing to S5005.

In S5009, the I/O request creation determination part 1420 determines whether or not there has been a limit violation regarding the maximum sectors limit 3516 in the I/O request queue table 3500. Specifically, the I/O request creation determination part 1420 determines whether or not the sum of the setting value for the total number of sectors 3314 of the I/O request information element 3350 and the setting value for the number of sectors 3111 of the I/O sector information element 3150 is equal to or less than the setting value for the maximum sectors limit 3516. When the result is that there has been a limit violation regarding the maximum sectors limit 3516 in the I/O request queue table 3500, that is, when the sum of the setting value for the total number of sectors 3314 of the I/O request information element 3350 and the setting value for the number of sectors 3111 of the I/O sector information element 3150 is not equal to or less than the setting value for the maximum sectors limit 3516 (S5009: Yes), the I/O request creation determination part 1420 moves the processing to S5005, and, alternatively, when there has not been a limit violation regarding the maximum sectors limit 3516 in the I/O request queue table 3500 (S5009: No), advances the processing to S5010.

In S5010, the I/O request creation determination part 1420 determines whether or not there has been a limit violation regarding the maximum segments limit 3517 in the I/O request queue table 3500. Specifically, the I/O request creation determination part 1420 determines whether or not the sum of the setting value for the total number of segments 3315 of the I/O request information element and the setting value for the number of segments 3114 of the I/O sector information element 3150 is equal to or less than the setting value for the maximum segments limit 3517. When the result is that there has been a limit violation regarding the maximum segments limit 3517 in the I/O request queue table 3500, that is, when the sum of the setting value for the total number of segments 3315 of the I/O request information element 3350 and the setting value for the number of segments 3114 of the I/O sector information element 3150 is not equal to or less than the setting value for the maximum segments limit 3517 (S5010: Yes), the I/O request creation determination part 1420 moves the processing to S5005, and, alternatively, when there has not been a limit violation regarding the maximum segments limit 3517 in the I/O request queue table 3500 (S5010: No), sends the I/O sector information element 3150 for which the target sectors are contiguous, and the I/O request information element 3350 to the I/O sector addition part 1421, and shifts the processing to the I/O sector addition part 1421.

Returning to the explanation of FIG. 16, the I/O sector addition part 1421, as indicated by arrow 1304B, receives the I/O sector information element 3150, and the I/O request information element 3350 targeting sectors that are contiguous to the range of sectors targeted by the I/O sector information element 3150. The I/O sector addition part 1421 determines, in accordance with the same processing as that of S5007 in FIG. 19, whether or not the range of sectors corresponding to the I/O sector information element 3150 is contiguous sectors preceding the start sector 3312 of the I/O request information element 3350.

When the result is that the range of sectors corresponding to the I/O sector information element 3150 is contiguous sectors preceding the start sector 3312 of the I/O request information element 3350, the I/O sector addition part 1421 changes the setting value for the start sector 3312 of the I/O request information element 3350 to the setting value for the start sector 3110 of the I/O sector information element 3150, adds the setting value for the number of sectors 3111 to the setting value for the number of non-transfer sectors 3313, adds the setting value for the number of sectors 3111 to the setting value for the total number of sectors 3314, adds the setting value for the number of segments 3114 to the setting value for the total number of segments 3315, changes the setting value for the I/O sector link pointer 3118 to the setting value for the first I/O sector pointer 3316, and changes the setting value for the first I/O sector pointer 3316 to that of the pointer to the I/O sector information element 3150. This makes it possible to integrate I/O processes targeted at contiguous areas into a single I/O request. That is, I/O processes targeted at contiguous areas can be executed as a single I/O process, the number of I/Os can be reduced, and, in addition, the overall time for I/O processing can be shortened. Alternatively, a case in which the range of sectors corresponding to the I/O sector information element 3150 is not contiguous sectors preceding the start sector 3312 of the I/O request information element 3350 signifies that the range of sectors corresponding to the I/O sector information element 3150 is contiguous sectors following the range of sectors corresponding to the I/O request information element 3350, and as such, the I/O sector addition part 1421 changes the setting value for the start sector 3312 to the setting value for the start sector 3110, adds the setting value for the number of sectors 3111 to the setting value for the number of non-transfer sectors 3313, adds the setting value for the number of sectors 3111 to the setting value for the total number of sectors 3314, adds the setting value for the number of segments 3114 to the setting value for the total number of segments 3315, changes the setting value for the I/O sector link pointer 3118 of the I/O sector information element 3153 indicated by the last I/O sector pointer 3317 to the setting value for the I/O sector information element 3150 pointer, and changes the setting value for the last I/O sector pointer 3317 to the setting value for the I/O sector information element 3150 pointer. This makes it possible to integrate I/O processes targeted at contiguous areas into a single I/O request. That is, I/O processes targeted at contiguous areas can be executed as a single I/O process, the number of I/Os can be reduced, and, in addition, the overall time for I/O processing can be shortened. Thereafter, the I/O sector addition part 1421 shifts the processing to the I/O request integration/addition determination part 1440.

The I/O request creation part 1422, as indicated by arrow 1304A1, receives the I/O sector information element 3150. Upon receiving the I/O sector information element 3150, the I/O request creation part 1422 creates the I/O request information element 3350 in the I/O request table 3300, configures the setting value for the R/W flag 3115 in the I/O sector information element 3150 to the setting value for the R/W flag 3310 in the I/O request information element 3350, configures the setting value for the I/O request list pointer 3511 in the I/O request queue table 3500 indicated by the I/O request queue table pointer 3113 to the setting value for the I/O request list pointer 3311, configures the setting value for the start sector 3110 to the setting value for the start sector 3312, configures the setting value for the number of sectors 3111 to the setting value for the number of non-transfer sectors 3313, configures the setting value for the number of sectors 3111 to the setting value for the total number of sectors 3314, configures the setting value for the number of segments 3114 to the setting value for the total number of segments 3315, and configures a pointer indicating the I/O sector information element 3150 to the setting value for the first I/O sector pointer 3316. In addition, in a case where the setting value for the number of requests 3510 in the I/O request queue table 3500 is less than one, the I/O request creation part 1422 stores a pointer indicating the I/O request information element 3350 in the setting value for the I/O request information element pointer 3710 of the I/O request list 3700. Alternatively, in a case where the setting value for the number of requests 3510 in the I/O request queue table 3500 is equal to or larger than one, the I/O request creation part 1422 stores the pointer indicating the I/O request information element 3350 in the setting value for an unused I/O request information element pointer of the I/O request list 3700, and, in addition, rearranges the I/O request information element pointers (3710, 3711, . . . ) stored in the I/O request list 3700 so that the setting values for the start sectors 3312 of the I/O request information elements 3350, 3351, . . . indicated by the respective I/O request information element pointers are lined up in ascending order. Thereafter, the I/O request creation part 1422 sends an instruction to the I/O request integration/addition determination part 1440 and shifts the processing to the I/O request integration/addition determination part 1440.

The I/O request integration/addition determination part 1440 receives an instruction from either the I/O sector addition part 1421 or the I/O request creation part 1422. The processing of the I/O request integration/addition determination part 1440 will be explained be referring to a drawing.

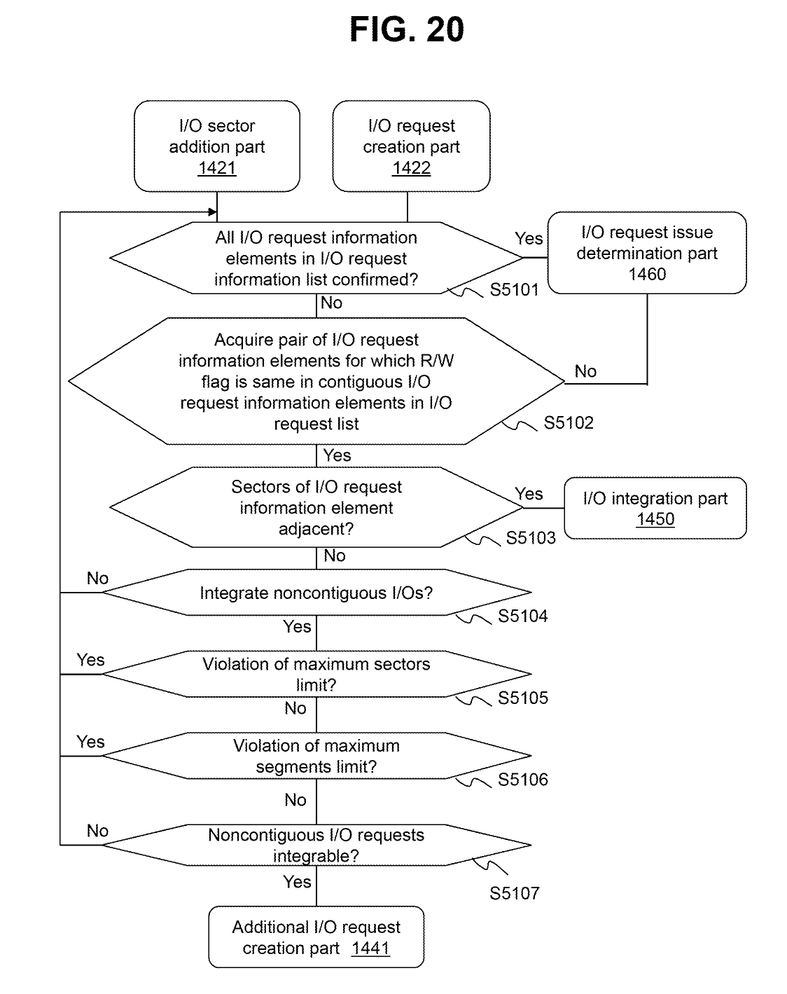

FIG. 20 is a flowchart of the processing of the I/O request integration/addition determination part 1440.

In S5101, the I/O request integration/addition determination part 1440 determines whether or not a check has been done using all the I/O request information element pointers in the I/O request list 3700 to make sure that the I/O request information elements are capable of being integrated. When the result is that a check has been done using all the I/O request information element pointers to make sure that the I/O request information elements are capable of being integrated (S5101: Yes), the I/O request integration/addition determination part 1440 shifts the processing to the I/O request issue determination part 1460, and, alternatively, when a check has not been done using all the I/O request information element pointers to make sure that the I/O request information elements are capable of being integrated (S5101: No), advances the processing to S5102.

In S5102, the I/O request integration/addition determination part 1440 determines whether or not a pair of I/O request information elements, which is contiguous I/O request information elements from the I/O request list 3700 and for which the respective R/W flag 3310 setting values are the same, is capable of being acquired. When the result is that such a pair of I/O request information elements is acquirable (S5102: Yes), the I/O request integration/addition determination part 1440 acquires the applicable pair of I/O request information elements and advances the processing to S5103, and, alternatively, when such a pair of I/O request information elements is not acquirable (S5102: No), shifts the processing to the I/O request issue determination part 1460.

In S5103, the I/O request integration/addition determination part 1440 determines whether or not the sectors targeted by each of the pair of I/O request information elements are contiguous. Specifically, the I/O request integration/addition determination part 1440 makes a determination in accordance with whether or not either the sum of the setting value for the start sector 3312 and the setting value for the total number of sectors 3314 of the one I/O request information element is equal to the setting value for the start sector 3312 of the other I/O request information element, or the sum of the setting value for the start sector 3312 and the setting value for the total number of sectors 3314 of the other I/O request information element is equal to the setting value for the start sector 3312 of the one I/O request information element 3350. When the result is that the sectors targeted by each of the pair of I/O request information elements are contiguous (S5103: Yes), the I/O request integration/addition determination part 1440 shifts the processing to the I/O integration part 1450, and, alternatively, when the sectors targeted by each of the pair of I/O request information elements are not contiguous (S5103: No), advances the processing to S5104.

In S5104, the I/O request integration/addition determination part 1440 determines whether or not to execute subsequent processing for integrating a pair of I/O request information elements for which the target sectors are non-contiguous as a single I/O request. Specifically, the I/O request integration/addition determination part 1440 determines whether or not the setting value for the RMW flag 3411 in the I/O environment configuration table 3400 is ON, and, in addition, whether or not the setting value for the R/W flag 3310 is WRITE. Or, the I/O request integration/addition determination part 1440 determines whether or not the setting value for the R/W flag 3310 is READ, and, in addition, whether or not the setting value for the cache flag 3412 is ON. Then, in a case where the setting value for the RMW flag 3411 in the I/O environment configuration table 3400 is ON, and, in addition, the setting value for the R/W flag 3310 is WRITE, or the setting value for the R/W flag 3310 is READ, and, in addition, the setting value for the cache flag 3412 is ON, the I/O request integration/addition determination part 1440 determines that the subsequent processing for integrating a pair of I/O request information elements for which the target sectors are non-contiguous will be executed as a single I/O request. When it has been determined that the result of S5104 is that the subsequent processing for integrating a pair of I/O request information elements for which the target sectors are non-contiguous will be executed as a single I/O request (S5104: Yes), the I/O request integration/addition determination part 1440 advances the processing to S5105, and, alternatively, when it has been determined that the subsequent processing for integrating a pair of I/O request information elements for which the target sectors are non-contiguous will not be executed as a single I/O request (S5104: No), moves the processing to S5101.

In S5105, the I/O request integration/addition determination part 1440 determines whether or not there has been a limit violation regarding the maximum sectors limit 3516 in the I/O request queue table 3500. Specifically, the I/O request integration/addition determination part 1440 determines whether or not the difference between the sum of the setting value for the start sector 3312 and the setting value for the total number of sectors 3314 of an I/O request information element for which the target area is in the posterior direction (called the posterior-target I/O request information element) and the setting value for the start sector 3312 of an I/O request information element for which the target area is in the anterior direction (called the anterior-target I/O request information element) is equal to or less than the setting value for the maximum sectors limit 3516. When the result is that the difference between the sum of the setting value for the start sector 3312 and the setting value for the total number of sectors 3314 of the I/O request information element for which the target area is in the posterior direction and the setting value for the start sector 3312 of the I/O request information element for which the target area is in the anterior direction is larger than the setting value for the maximum sectors limit 3516, that is, when there has been a limit violation regarding the maximum sectors limit 3516 in the I/O request queue table 3500 (S5105: Yes), the I/O request integration/addition determination part 1440 moves the processing to S5101, and, alternatively, when the difference between the sum of the setting value for the start sector 3312 and the setting value for the total number of sectors 3314 of the posterior-target I/O request information element and the setting value for the start sector 3312 of the anterior-target I/O request information element is equal to or less than the setting value for the maximum sectors limit 3516, that is, when there has not been a limit violation regarding the maximum sectors limit 3516 in the I/O request queue table 3500 (S5105: No), advances the processing to S5106.

In S5106, the I/O request integration/addition determination part 1440 determines whether or not there has been a limit violation regarding the maximum segments limit 3517 in the I/O request queue table 3500. Specifically, the I/O request integration/addition determination part 1440 determines whether or not the sum of the setting value for the total number of segments 3315 of a pair of I/O request information elements is equal to or less than the setting value for the maximum segments limit 3517. When the result is that there has been a limit violation regarding the maximum segments limit 3517 in the I/O request queue table 3500 (S5106: Yes), it is not possible to integrate the I/O requests into a single I/O request, and as such, the I/O request integration/addition determination part 1440 moves the processing to S5101, and, alternatively, when there has not been a limit violation regarding the maximum segments limit 3517 in the I/O request queue table 3500 (S5106: No), advances the processing to S5107.

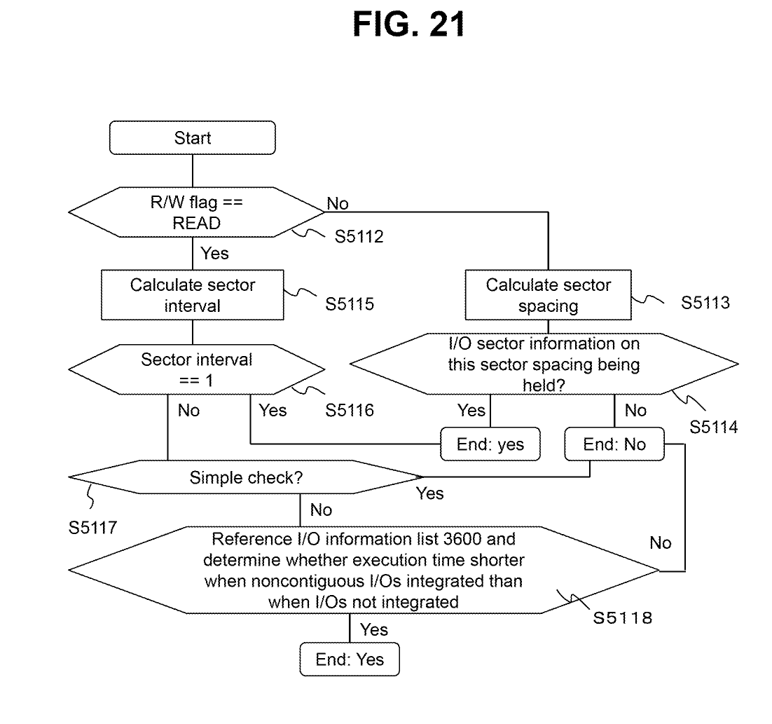

In S5107, the I/O request integration/addition determination part 1440 executes determination processing (Refer to FIG. 21) for once again determining whether or not it is possible to integrate a pair of I/O request information elements for which the target sectors are non-contiguous as a single I/O request. When the result is a determination that the pair of I/O request information elements for which the target sectors are non-contiguous can be integrated as a single I/O request (S5107: Yes), the I/O request integration/addition determination part 1440 sends the pair of I/O request information elements to the additional I/O sector creation part 1441 and shifts the processing to the additional I/O sector creation part 1441, and, alternatively, when it has been determined that the pair of I/O request information elements for which the target sectors are non-contiguous cannot be integrated as a single I/O request (S5107: No), moves the processing to S5101.

The determination processing of S5107 will be explained by referring to a drawing.

FIG. 21 is a flowchart of the determination processing of the I/O request integration/addition determination part 1440.

In S5112, the I/O request integration/addition determination part 1440 determines whether or not the setting value for the R/W flag 3310 of the I/O request information element 3350 is READ. When the result is that the setting value for the R/W flag 3310 is READ (S5112: Yes), the I/O request integration/addition determination part 1440 advances the processing to S5115, and, alternatively, when the setting value of the R/W flag 3310 is not READ (S5112: No), advances the processing to S5113.

In S5113, the I/O request integration/addition determination part 1440 calculates the interval (open sector interval) that exists between the areas targeted by each of the pair of I/O request information elements. A start sector A of the open sector interval is determined by the sum of the setting value for the start sector 3312 of an I/O request information element for which the target area is in the anterior direction and the setting value for the total number of sectors 3314. Also, a number of sectors B of an open sector interval is determined by the difference between the setting value for the start sector 3312 of an I/O request information element for which the target area is in the posterior direction and the start sector A of the open sector interval.

In S5114, the I/O request integration/addition determination part 1440 determines whether or not an I/O sector information element corresponding to the open sector interval defined by the start sector A and the number of sectors B exists in the I/O sector reference table 3800. Since the existence in the I/O sector reference table 3800 of an I/O sector information element corresponding to the open sector interval (S5114: Yes) indicates that data corresponding to the open sector interval is cached in the storage part 1700, the I/O request integration/addition determination part 1440 determines that the result of the determination process is Yes. In accordance with this, the pair of I/O request information elements is integrated into a single I/O request which is executed as a single I/O process. Alternatively, when an I/O sector information element corresponding to the open sector interval does not exist in the I/O sector reference table 3800 (S5114: No), the I/O request integration/addition determination part 1440 determines that the determination result is No.

In S5115, the I/O request integration/addition determination part 1440 calculates the number of open sectors (sector spacing: size of the open sector space) between the intervals targeted by each of the pair of I/O request information elements. The number of open sectors can be calculated using the same processing as that for the number of sectors B in S5113.

In S5116, the I/O request integration/addition determination part 1440 determines whether or not the sector spacing is equal to or less than a predetermined number. Since the intervals targeted by each of the pair of I/O request information elements are not contiguous, and the sector spacing does not become 0, when the predetermined number is one, a sector spacing of equal to or less than the predetermined number has to be 1, which is why an effort is made to determine whether or not the sector spacing coincides with one in the example of FIG. 21. The predetermined number is not limited to one, and can be a number of two or more, the point being that the sector spacing should be such that it is possible to assure with a relatively high probability that execution time will be shorter when I/O processing is executed as a single request than when executing I/O processing as several I/O requests.

When the result is that the sector spacing is equal to or less than the predetermined number (S5116: Yes), the integration of the I/O requests into a single I/O request will definitely shorten the execution time for I/O processing, and as such, the I/O request integration/addition determination part 1440 determines that the result of the determination process is Yes. In accordance with this, the pair of I/O request information elements is integrated into a single I/O request, and executed as a single I/O process, thereby making it possible to reduce the number of I/O processes and to shorten the I/O processing time. Alternatively, when the sector spacing exceeds the predetermined number (S5116: No), the I/O request integration/addition determination part 1440 advances the processing to S5117.

In S5117, the I/O request integration/addition determination part 1440 determines whether or not the setting value for the simple check flag 3413 of the I/O environment configuration table 3400 is ON. A case in which the result is that the setting value of the simple check flag 3413 is ON (S5117: Yes) signifies only a simple check (the check of S5116), and as such, the I/O request integration/addition determination part 1440 determines that the result of the determination processing is No. Alternatively, a case in which the setting value of the simple check flag 3413 is OFF (S5117: No) signifies that a subsequent detailed check is to be performed, and as such, the I/O request integration/addition determination part 1440 advances the processing to S5118.

In S5118, the I/O request integration/addition determination part 1440 references the I/O information list 3600, and determines whether or not integrating a pair of I/O request information elements targeted at non-contiguous areas into a single I/O request can shorten the execution time of the I/O processing by the storage device 1800. The estimated execution time in a case where I/O processes corresponding to the I/O request information elements are executed separately (individual execution time: first processing time) can be estimated for each I/O request information element here by identifying the I/O information element 3650 for which the total number of sectors 3314 and total number of segments 3315, and the setting value of the total number of sectors 3610 and the setting value of the total number of segments 3611 for the I/O information element in the I/O information list 3600 are the closest values, calculating the difference between the setting value for the start time 3612 and the setting value for the end time 3613 for this I/O information element as the execution time for the I/O processes corresponding to each I/O request information element, and adopting the sum of the execution times of the pair of I/O request information elements 3351. In addition, the estimated execution time in a case where I/O processing is executed by integrating the I/O requests of a pair of I/O request information elements targeted at non-contiguous areas into a single I/O request (integrated execution time: second processing time) can be estimated by calculating an integration total number of sectors and an integration total number of segments determined by taking the respective sums of the total number of sectors 3314 and the total number of segments 3315 of the pair of I/O request information elements, calculating a post-integration total number of sectors obtained by adding the number of sectors corresponding to the non-contiguous intervals (non-contiguous areas) to the integration total number of sectors, identifying the I/O information element for which the post-integration total number of sectors and the integration total number of segments, and the setting value for the total number of sectors 3610 and the setting value for the total number of segments 3611 for the I/O information element in the I/O information list 3600 are the closest values, and calculating the difference between the setting value for the start time 3612 and the setting value for the end time 3613 for this I/O information element. The I/O request integration/addition determination part 1440 determines whether or not the execution time in a case where the I/O processing is executed by integrating the I/O request of the pair of non-contiguous I/O request information elements is shorter than the execution time in a case where the I/O requests are not integrated.

As a result, when it has been determined that integrating the pair of I/O request information elements targeted at non-contiguous areas as a single I/O request can shorten the execution time for the I/O processing of the storage device 1800 (S5118: Yes), the I/O request integration/addition determination part 1440 determines that the result of the determination process is Yes. In accordance therewith, when it is estimated that the execution time in a case where I/O processing is executed by integrating the I/O requests of the pair of non-contiguous I/O request information elements will be shorter that the execution time in a case where the I/O requests are not integrated, the I/O requests are integrated into a single I/O request and executed as a single I/O process, thereby making it possible to reduce the number of I/O processes and to shorten the I/O processing time. Alternatively, when it has been determined that integrating the pair of I/O request information elements targeted at non-contiguous areas as a single I/O request cannot shorten the execution time for the I/O processing of the storage device 1800 (S5118: No), the I/O request integration/addition determination part 1440 determines that the result of the determination process is No.

Returning to the explanation of FIG. 16, the additional I/O sector creation part 1441, based on the pair of I/O request information elements received from the I/O request integration/addition determination part 1440, adds an I/O sector information element and an I/O segment information element that corresponds to sector areas added when integrating the I/O requests of this pair of I/O request information elements, that is, sector areas (additional areas) added to make the non-contiguous areas targeted by this pair of I/O request information elements into contiguous areas. Specifically, first the additional I/O sector creation part 1441 determines whether or not the setting value for the R/W flag 3310 for the pair of I/O request information elements is READ.

When the result is that the setting value for the R/W flag 3310 is READ, the additional I/O sector creation part 1441 creates an I/O sector information element, and replicates the setting value 3102 of the I/O sector information element corresponding to the I/O request information element in the setting values 3102 of each item 3101 of the I/O request information element. In addition, the additional I/O sector creation part 1441 calculates a start sector A and a number of sectors B for an additional interval using the same method as that of S5114, and configures the start sector A and the number of sectors B in the start sector 3110 and the number of sectors 3111 of the created I/O sector information element. The additional I/O sector creation part 1441 also configures the setting value for the additional I/O flag 3120 to ON indicating an additional area. Next, the additional I/O sector creation part 1441 creates either one or a plurality of I/O segment information elements for indicating an area of the storage part 1700 for which the address length is the same as that of the number of sectors B. Next, the additional I/O sector creation part 1441 configures a pointer to the I/O segment table 3200, which includes the created either one or plurality of I/O segment information elements, in the setting value for the I/O segment table pointer 3112 of the created I/O sector information element, and configures the number of created I/O segment information elements in the number of segments 3114. Alternatively, when the setting value for the R/W flag 3310 is WRITE, the additional I/O sector creation part 1441 calculates the start sector A and the number of sectors B for the additional area using the same method as that of S5114, and, from the I/O sector reference table 3800, identifies the I/O sector information element corresponding to the area that includes the additional area indicated by the start sector A and the number of sectors B. The additional I/O sector creation part 1441 deletes the I/O sector information element pointer for the I/O sector information element identified from the I/O sector reference table 3800.

In addition, the additional I/O sector creation part 1441, in a case where the start sector 3110 of the identified I/O sector information element differs from the start sector A, deletes the I/O segment information element indicating the area corresponding to the difference area of the setting value for the start sector 3110 and the start sector A, and, in addition, uses a value obtained by subtracting the difference between the setting value for the start sector 3110 and the start sector A from the setting value for the number of sectors 3111 as a new setting value, and uses a value obtained by subtracting the number of deleted I/O segment information elements from the setting value for the number of segments 3114 as a new setting value. The additional I/O sector creation part 1441, in a case where the setting value for the number of sectors 3111 differs from the number of sectors B, also deletes the I/O segment information element indicating the area corresponding to the area indicated by the difference between the setting value for the number of sectors 3111 and the number of sectors B, uses the setting value for the number of sectors 3111 as the number of sectors B, and subtracts only the number of deleted I/O segment information elements from the setting value of the number of segments 3114. Next, the additional I/O sector creation part 1441 configures the setting value for the R/W flag 3115 of the identified I/O segment information element to WRITE, and configures the setting value for the additional I/O flag 3120 to ON.

The additional I/O sector creation part 1441, after adding the I/O sector information element, as indicated by arrow 1305B2, sends the I/O sector information element and the pair of I/O request information elements to the I/O sector addition part 1442.

The I/O sector addition part 1442, upon receiving the I/O sector information element and the pair of I/O request information elements from the additional I/O sector creation part 1441, performs the same processing as that of the I/O sector addition part 1421 when the sum of the setting value for the number of segments 3114 of the received I/O sector information element and the total number of sectors 3314 of the pair of I/O request information elements is equal to or less than the setting value for the maximum segments limit 3517, and, as indicated by arrow 1305B3, sends the pair of I/O request information elements to the I/O integration part 1450. The I/O integration part 1450 integrates the pair of I/O request information elements received from the I/O sector addition part 1442 into a single I/O request information element. Specifically, the I/O integration part 1450 adds the setting value for the posterior-target I/O request information element to the setting values for the number of non-transfer sectors 3313, the total number of sectors 3314, and the total number of segments 3315 of the I/O request information element for which the setting value for the start sector 3312 is small (that is, the anterior-target I/O request information element), uses the setting value for the I/O sector link pointer 3118 of the I/O sector information element indicated by the last I/O sector pointer 3317 of the anterior-target I/O request information element as the setting value for the first I/O sector pointer 3316 of the posterior-target I/O request information element, and uses the setting value for the last I/O sector pointer 3317 of the anterior-target I/O request information element as the setting value for the last I/O sector pointer 3317 of the posterior-target I/O request information element. Thereafter, the I/O integration part 1450 deletes the item and the setting value corresponding to the posterior-target I/O request information element from the I/O request list 3700 indicated by the setting value for the I/O request list pointer 3311 of the anterior-target I/O request information element, and deletes the posterior-target I/O request information element. In accordance with this processing, the anterior-target I/O request information element comes to have as its target contiguous areas that include the additional area and the area targeted by the posterior-target I/O request information element. That is, the I/O request information elements are integrated into a single I/O request information element.

Lastly, the I/O integration part 1450 shifts the processing to the I/O request issue determination part 1460 as indicated by arrow 1306.

The I/O request issue determination part 1460 determines whether or not an I/O request should be issued. Specifically, first of all, the I/O request issue determination part 1460, either when the difference between the current time and the setting value for the start time 3518 in the I/O request queue table 3500 is equal to or larger than the setting value for the maximum retention time limit 3514, or when the setting value for the number of requests 3510 is equal to or larger than the setting value for the maximum requests limit 3515, closes the setting value for the plug flag 3513, configures the setting value for the status flag 3512 to not receivable, and, as indicated by arrow 1307, shifts the processing to the I/O sector reference table update part 1470. Alternatively, in a case other than the aforementioned cases, the I/O request issue determination part 1460 configures the setting value for the status flag 3512 to receivable, and repeatedly executes I/O request issue determination part 1460 processing until the I/O sector information element 3150 is received from the universal block part 1300.

The I/O sector reference table update part 1470 determines whether or not the sector area targeted by the I/O request information element indicated by the I/O request list 3700 on the basis of the I/O request list pointer 3511 of the I/O request queue table 3500 overlaps with the sector area targeted by the I/O sector information element indicated by the I/O sector reference table 3800, and when these sector areas overlap, deletes the pointer of the I/O sector information element in which the targeted sector areas overlap from the I/O sector reference table 3800, and thereafter shifts the processing to the I/O information configuration part 1480.

The I/O information configuration part 1480 creates, in the I/O information list 3600 indicated by the I/O information list pointer 3519 of the I/O request queue table 3500, I/O information elements equivalent to the number of I/O request information elements registered in the I/O request list 3700 indicated by the setting value for the I/O request list pointer 3511 of the I/O request queue table 3500. Specifically, the I/O information configuration part 1480 configures the setting values of the total number of sectors 3610 and the total number of segments 3611 for each I/O information element in the total number of sectors 3314 and the total number of segments 3315 for each I/O request information element, records the current time in the setting value for the start time 3612 for each I/O information element and in the setting values for the start times 3119 of all the I/O sector information elements corresponding to each I/O request information element, and configures the setting value for the I/O information list pointer 3519 in the setting value for the I/O information list pointer 3117 for all the I/O sector information elements corresponding to each I/O request information element. Lastly, the I/O information configuration part 1480 sends the I/O request list 3700 indicated by the I/O request list pointer 3511 to the device driver part 1500 as indicated by arrow 1401.

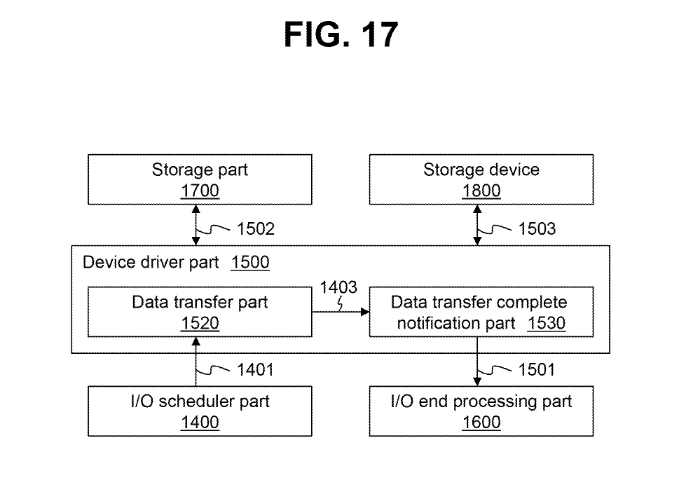

FIG. 17 is a functional block diagram of the device driver part 1500.

The device driver part 1500 comprises a data transfer part 1520 and a data transfer complete notification part 1530.

The data transfer part 1520 receives the I/O request list 3700 from the I/O scheduler part 1400. The data transfer part 1520, upon receiving the I/O request list 3700, in a case where the setting value of the R/W flag 3310 of the I/O request information element indicated by the I/O request list 3700 is READ, reads from the storage device 1800 data of an area equivalent to the number of sectors indicated by the setting value for the number of sectors 3111 beginning from the start sector indicated by the setting value for the start sector 3110 of the I/O sector information element indicated by the first I/O sector pointer 3316 of the I/O request information element, and writes the read data to an area of the storage part 1700 equivalent to the address length of the setting value for the address length 3211 beginning from an address that is the setting value for the offset 3212 after the start address indicated by the setting value for the start address 3210 of the I/O segment information element in the I/O segment table 3200 indicated by the setting value for the I/O segment table pointer 3112. In this arrangement, the data transfer part 1520 is also able to write the data read from the sectors in a distributive manner to a plurality of areas corresponding to a plurality of I/O segment information elements.

When all the data transfers of areas corresponding to the I/O sector information element have ended, the data transfer part 1520 subtracts the setting value for the number of sectors 3111 of the I/O sector information element from the setting value for the number of non-transfer sectors 3313 of the I/O request information element, and, as indicated by arrow 1403, transfers the I/O sector information element to the data transfer complete notification part 1530.

Alternatively, when the R/W flag 3310 of the I/O request information element indicated by the I/O request list 3700 is WRITE, the data transfer part 1520 reads data from the area corresponding to the I/O segment information element of the storage part 1700, and writes the read data from the storage part 1700 to an area from the start sector of the I/O sector information element of the storage device 1800 up to a number of sectors equivalent to the setting value for the number of sectors 3111.

Thereafter, the data transfer part 1520 updates the setting value for the number of non-transfer sectors 3313 of the I/O request information element, and transfers the I/O sector information element to the data transfer complete notification part 1530. The data transfer part 1520 also configures the setting value for the plug flag 3513 in the I/O request queue table 3500 to open when processing the I/O processes indicated by all of the I/O request information elements that are indicated in the I/O request list 3700.

The data transfer complete notification part 1530 notifies the I/O end processing part 1600 of a processing instruction, which is the setting value for the I/O end processing setting 3116 of the I/O sector information element.

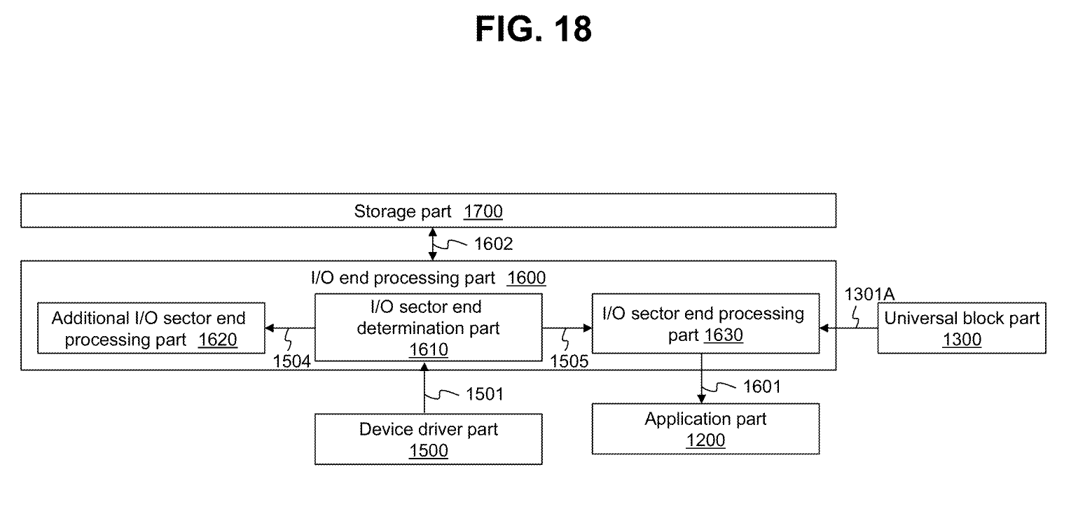

FIG. 18 is a functional block diagram of the I/O end processing part 1600.

The I/O end processing part 1600 comprises an I/O sector end determination part 1610, an additional I/O sector end processing part 1620, and an I/O sector end processing part 1630.

The I/O sector end determination part 1610, as indicated by arrow 1501, receives an I/O sector information element from the device driver part 1500. The processing of the I/O sector end determination part 1610 in a case where an I/O sector information element has been received will be explained using a different drawing.

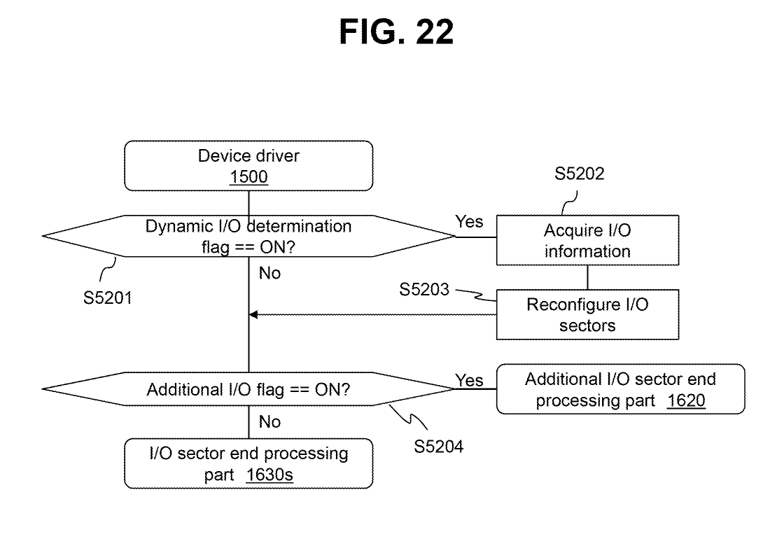

FIG. 22 is a flowchart of the processing of the I/O sector end determination part 1610.

In S5201, the I/O sector end determination part 1610 determines whether or not the setting value for the dynamic I/O determination flag 3410 in the I/O environment configuration table 3400 is ON. When the result is that the setting value for the dynamic I/O determination flag 3410 is ON, the I/O sector end determination part 1610 advances the processing to S5202, and, alternatively, when the setting value for the dynamic I/O determination flag 3410 is OFF, the I/O sector end determination part 1610 advances the processing to S5204.

In S5202, the I/O sector end determination part 1610 acquires from the I/O information list 3600 an I/O information element having a setting value for the start time 3612 that is the same as that of the setting value for the start time 3119 of the I/O sector information element, writes the current time to the setting value of the end time 3613 of the acquired I/O information element, and adds the setting value for the number of sectors 3111 to the setting value for the number of ended sectors 3614.

In S5203, the I/O sector end determination part 1610 acquires an end processing setting (for example, the I/O end processing setting A) from the I/O sector reconstruction table 3900 using the ID of the I/O sector information pointer, and changes the setting value for the I/O end processing setting 3116 of the I/O sector information element to the acquired end processing setting.

In S5204, the I/O sector end determination part 1610 determines whether or not the setting value for the additional I/O flag 3120 of the I/O sector information element is ON. When the result is that the setting value for the additional I/O flag 3120 is ON (S5204: Yes), the I/O sector end determination part 1610 sends the I/O sector information element to the additional I/O sector end processing part 1620, and shifts the processing to the additional I/O sector end processing part 1620, and, alternatively, when the result is that the setting value for the additional I/O flag 3120 is not ON (S5204: No), the I/O sector end determination part 1610 boots up the I/O sector end processing part 1630 so as to execute processing corresponding to the setting value for the I/O end processing setting 3116.

Returning to the explanation of FIG. 18, the additional I/O sector end processing part 1620 ends the processing as-is when the setting value for the R/W flag 3115 of the I/O sector information element received from the I/O sector end determination part 1610 is WRITE. Alternatively, when the setting value for the R/W flag 3115 of the I/O sector information element is READ, and either the setting value for the RMW flag 3411 of the I/O environment configuration table 3400 is ON or the setting value for the cache flag 3412 of the I/O environment configuration table 3400 is ON, the additional I/O sector end processing part 1620 adds a pointer to the I/O sector information element to the I/O sector reference table 3800, and, alternatively, in a case other than that described above, does not update the I/O sector reference table 3800.

Thus, when the setting value for the RMW flag 3411 is ON, that is, when RMW is performed or caching is required, an effort is made to register in the I/O sector reference table 3800 data corresponding to an additional area of data that was not needed originally, thereby making it possible to use this data later on by referencing the I/O sector reference table 3800, acquiring the I/O sector information element, and identifying the additional area data cached in the storage part 1700. For example, the application part 1200 processing may be performed to process the read data, create update data, and write this update data to the storage device 1800, and when RMW is performed in relation to the storage device 1800, data in an area contiguous to an area of data used in the processing of the storage device 1800 is generally read from the storage device 1800, and using the update data and the contiguous data, data is written to another area of the storage device 1800, but in this embodiment, the data of the area contiguous to the area of the read data, that is, the additional area data that was not needed in the processing of the application part 1200 is cached in the storage part 1700, thereby making it possible to reduce the need for reading the data required for RMW from the storage device 1800, and to decrease processing. Also, since the storage device 1800 need not execute processing corresponding to RMW, the processing of the storage device 1800 can be decreased.

The I/O sector end processing part 1630 executes end processing configured as the I/O end processing setting 3116 instructed from the I/O sector end determination part 1610, and, as indicated by arrow 1601, sends an I/O processing complete notification to the application part 1200. In accordance therewith, the application part 1200 receives the I/O processing complete notification from the I/O end processing part 1600 and continues predetermined processing.

An embodiment has been explained hereinabove, but needless to say the present invention is not limited to this embodiment, and various changes can be made without departing from the gist thereof.

What is claimed is:

1. An I/O processing control apparatus for controlling I/O processing in relation to a storage device, comprising:
a storage part configured to store a plurality of unprocessed I/O requests destined for the storage device;
an I/O scheduler part configured to integrate, from among the plurality of I/O requests, two or more I/O requests, which are for the same type of I/O process and have two or more noncontiguous areas as I/O destinations, into one I/O request that has one continuous area comprising the two or more noncontiguous areas as the I/O destination; and
a device driver part configured to execute I/O processing in relation to the storage device on the basis of the integrated I/O request.

2. The I/O processing control apparatus according to claim 1,
wherein the two or more I/O requests are two or more read requests.

3. The I/O processing control apparatus according to claim 2,
wherein the two or more read requests are two or more read requests for which estimation is made that processing time will be shortened by integrating read processes into a single read process rather than executing the read processes independently.

4. The I/O processing control apparatus according to claim 3,
wherein the storage part is further configured to store I/O information associating information that makes it possible to identify the length of an area targeted by an executed read process with information that makes it possible to identify the time required for execution of the read processing,
wherein the I/O scheduler part is configured to estimate, based on the I/O information, a first processing time estimated to be needed for executing any M (where M is an integer of equal to or larger than 2) read requests from among the plurality of I/O requests as independent read processes, and a second processing time estimated to be needed for executing read processing by integrating the M read requests into a single read request, and
wherein the second processing time for the two or more read requests is shorter than the first processing time for the two or more read requests.

5. The I/O processing control apparatus according to claim 2,
wherein each area interval in the two or more noncontiguous areas is equal to or less than a predetermined size.

6. The I/O processing control apparatus according to claim 1, further comprising an I/O end processing part configured to store in a storage part data that has been read from an additional area, which is an area other than the two or more noncontiguous areas within the continuous area, and also storing information for identifying the additional area after associating the data and the information with each other.

7. The I/O processing control apparatus according to claim 1,
wherein the storage part is configured to store at least a portion of the data read in accordance with an executed read process,
wherein the two or more I/O requests are each write requests, and
wherein data that is being stored in an area between areas in the two or more noncontiguous areas is stored in the storage part.

8. The I/O processing control apparatus according to claim 1,
wherein the I/O scheduler is configured to, in a case where an I/O destination area of a first I/O request, which is a new I/O request for the storage device, is contiguous with an I/O destination area of a second I/O request, which is any I/O request in the storage area, integrate the first I/O request and the second I/O request into a single I/O request.

9. An I/O processing control method comprising:
integrating, from among a plurality of I/O requests, two or more I/O requests, which are for the same type of I/O process and have two or more noncontiguous areas as I/O destinations, into one I/O request that has one continuous area comprising the two or more noncontiguous areas as the I/O destination; and
executing I/O processing in relation to the storage device on the basis of the integrated I/O request.

10. The I/O processing control method according to claim 9,
wherein the two or more I/O requests are two or more read requests.

11. The I/O processing control method according to claim 10,
wherein the two or more read requests are two or more read requests for which it is estimated that processing time will be shortened by integrating read processes into a single read process rather than executing the read processes independently.

12. The I/O processing control method according to claim 11, further comprising:
estimating, on the basis of I/O information associating information that makes it possible to identify the length of an area targeted by executed read processing with information that makes it possible to identify the time required for execution of the read processing, a first processing time estimated to be needed for executing any M (where M is an integer of equal to or larger than 2) read requests from among the plurality of I/O requests as independent read processes, and a second processing time estimated to be needed for executing read processing by integrating the M read requests into a single read request, wherein
the second processing time for the two or more read requests is shorter than the first processing time for the two or more read requests.

13. The I/O processing control method according to claim 10, wherein each area interval in the two or more noncontiguous areas is equal to or less than a predetermined size.

14. The I/O processing control method according to claim 9, further comprising:
associating data that has been read from an additional area, which is an area other than the two or more noncontiguous areas within the continuous area, with information for identifying the additional area.

15. The I/O processing control method according to claim 9,
wherein the two or more I/O requests are each write requests, and
wherein data that is being stored in an area between areas in the two or more noncontiguous areas is stored in a storage area separate from the storage device.
